(19) United States
(12) Patent Application Publication
(10) Pub. No.: US 2011/0083136 A1
(43) Pub. Date: Apr. 7, 2011

(54) DISTRIBUTED PROCESSING SYSTEM

(75) Inventors: Arata SHINOZAKI, Tokyo (JP); Mitsunori KUBO, Tokyo (JP); Takayuki NAKATOMI, Tokyo (JP)

(73) Assignee: OLYMPUS CORPORATION, Tokyo (JP)

(21) Appl. No.: 12/893,515

(22) Filed: Sep. 29, 2010

(30) Foreign Application Priority Data
Oct. 1, 2009 (JP) 2009-229252

(51) Int. Cl. G06F 9/46

(52) U.S. Cl. 718/107

(57) ABSTRACT

A distributed processing system for executing an application includes a processing element capable of performing parallel processing, a control unit, and a client that makes a request for execution of the application to the control unit. The processing element has, at least at the time of executing the application, one or more processing blocks that process respectively one or more tasks to be executed by the processing element, a processing block control section for calculating the number of parallel processes based on an index for controlling the number of parallel processes received from the control unit, a division section that divides data to be processed input to the processing blocks by the processing block control section in accordance with the number of parallel processes, and an integration section that integrates processed data output from the processing blocks by the processing block control section in accordance with the number of parallel processes.

### CROSS-REFERENCE TO RELATED APPLICATION

The present application is based upon and claims the benefit of priority from the prior Japanese Patent Application No. 2009-229252 filed on Oct. 1, 2009; the entire contents of which are incorporated herein by reference.

### BACKGROUND OF THE INVENTION

1. Field of the Invention

The present invention relates to a distributed processing system.

2. Description of the Related Art

In some conventional distributed processing systems, an application required by a user is input to the system as a program or interconnection information to perform parallel processing. A program written in a high-level programming language can be written regardless of whether the processing system performs sequential processing or parallel processing. If parallel processing is to be executed in such a program, the portion of the sequentially executed program that can be executed in parallel is automatically extracted, then division of data and division of program are performed, and then it is determined whether or not a communication between computation modules is required. This type of method of generating a parallel program has been disclosed, for example, in Japanese Patent Application Laid-Open No. 8-328872.

### SUMMARY OF THE INVENTION

A distributed processing system according to the present invention is a distributed processing system for executing an application including a processing element capable of performing parallel processing, a control unit, and a client that makes a request for execution of an application to the control unit, wherein, the processing element comprises, at least at the time of executing the application, one or more processing blocks that process respectively one or more tasks to be executed by the processing element, a processing block control section for calculating the number of parallel processes based on an index for controlling the number of parallel processes received from the control unit, a division section that divides data to be processed input to the processing blocks by the processing block control section in accordance with the number of parallel processes, and an integration section that integrates processed data output from the processing blocks by the processing block control section in accordance with the number of parallel processes.

### BRIEF DESCRIPTION OF THE DRAWINGS

FIG. 1 is a diagram schematically showing the configuration of a distributed processing system according to an embodiment of the present invention;

FIG. 2 is a flow chart of a process of an application according to an embodiment of the present invention;

FIG. 3 is a table stating the correspondence between the service shown in FIG. 2 and tasks that constitute the service;

FIG. 4 is a table showing exemplary items of information constituting execution transition information and exemplary data of the respective items of the information according to an embodiment of the present invention;

FIG. 5 shows an exemplary system model corresponding to the configuration specified by the execution transition information shown in FIG. 4;

FIG. 6 is a table showing an exemplary configuration of a service policy according to an embodiment of the present invention;

FIG. 7 is a table showing an exemplary configuration of a task policy according to an embodiment of the present invention;

FIG. 8 is a flowchart showing a process of an application according to a first embodiment;

FIG. 9 is a chart showing a sequence of the execution of a service according to the first embodiment;

FIG. 10 shows an example of PE registration information according to the first embodiment;

FIG. 11 is a graph showing an exemplary profile according to the first embodiment;

FIG. 12 is a table showing an example of PE registration information of a processing element PE1 according to the first embodiment;

FIG. 13 is a table showing an example of PE registration information of a processing element PE4 (VPE) according to the first embodiment;

FIG. 14 is a table showing an example of presentation of choices in the task policy according to the first embodiment;

FIG. 15 is a table showing an exemplary task policy after the determination made by a client according to the first embodiment;

FIG. 16 is a chart showing a sequence of the execution of a service according to a second embodiment;

FIG. 17 is a table showing an example of PE registration information of a processing element PE1 according to the second embodiment;

FIG. 18 is a table showing an example of PE registration information of a processing element PE4 according to the second embodiment;

FIG. 19 is a table showing an exemplary service policy specified by a client according to the second embodiment;

FIG. 20 is a table showing an exemplary task policy determined based on the service policy according to the second embodiment;

FIG. 21 is a chart showing a sequence of the execution of a service according to a third embodiment;

FIG. 22 is a table showing an exemplary service policy registered by a client according to the third embodiment;

FIG. 23 is a chart showing a sequence of the execution of a service in the case in which the control unit presents alternatives according to a fourth embodiment;

FIG. 24 shows an example of a GUI window presenting alternatives displayed on the client according to the fourth embodiment;

FIG. 25 is a chart showing a sequence of the execution of a service in the case in which entry is restricted on the client according to a fifth embodiment;

FIG. 26 shows an exemplary case of the restriction of entry on the GUI window on the client according to the fifth embodiment;

FIG. 27 is a table showing an exemplary task policy in which the priority levels are specified according to a sixth embodiment;

FIG. 28 is a flow chart of a process of adjusting the numbers of parallel processes between tasks at the time of executing two tasks while taking into account the priority levels of two tasks according to the sixth embodiment;

FIG. 29 is a diagram showing a status of a processing element PE4 in which a task is executed with the number of parallel processes equal to 1 according to the sixth embodiment;

FIG. 30 is a diagram showing an exemplary configuration of a processing element in which a processing block is a general-purpose processing block according to a seventh embodiment;

FIG. 31 is a diagram showing the initial state of a processing element according to the seventh embodiment;

FIG. 32 is a chart showing a sequence of the execution of a service according to the seventh embodiment;

FIG. 33 is a table showing an example of PE registration information for a processing element having a general-purpose processing block according to the seventh embodiment;

FIG. 34 is a diagram showing a state in which a library is loaded to a GP-PB according to the seventh embodiment;

FIG. 35 is a diagram showing a state in which a GP-PB and a library are copied in combination according to the seventh embodiment;

FIGS. 36 to 38 are a series of diagrams showing states in a process in which a GP-PB and a library are loaded and copied separately according to the seventh embodiment, where FIG. 36 shows a state before the GP-PB and the library are copied, FIG. 37 shows a state in which the GP-PB is copied, and FIG. 38 shows a state in which the library is copied and loaded;

FIGS. 39 to 42 are a series of diagrams showing states in a process in which only a library is loaded and copied according to the seventh embodiment, where FIG. 39 shows a state before the library is copied, FIG. 40 shows a state in which the library delivered from the control unit is held and copied, FIG. 41 shows a state in which the copied library is loaded to GP-PBs, and FIG. 42 shows a state in which the library and the processing block are deleted;

FIG. 43 is a table showing an example of PE registration information for a processing element having a GP-PB and a library according to the seventh embodiment;

FIG. 44 is a diagram showing a state in which the GP-PB has been unloaded and completely deleted or reloaded and the configuration of holding sections according to the seventh embodiment;

FIGS. 45 to 47 are diagrams showing states in a process in which a special-purpose processing block PB is copied, where FIG. 45 shows a state in which a special-purpose processing block holding section copies a processing block and loads it as another processing block to enable processing, FIG. 46 shows a state in which the special-purpose processing block holding section unloads all the processing blocks and holds them, or unloads all the processing blocks and reloads them to enable processing, and FIG. 47 shows a state in which the special-purpose processing block holding section deletes all the processing blocks;

FIG. 48 is a diagram showing an example of dynamic switching to processing blocks implemented as hardware according to an eighth embodiment;

FIG. 49 is a diagram showing a state in which all the switches are opened according to the eighth embodiment;

FIGS. 50 to 54 are a series of diagrams showing an exemplary configuration in which a dynamic reconfigurable processor is used as a processing block according to the eighth embodiment, where FIG. 50 shows an example of dynamic switching to a dynamic reconfigurable processing block, FIG. 51 shows a state in which the control unit loads reconfiguration information obtained from a database server to the dynamic reconfigurable processing block through a load section, or a state in which the control unit loads the reconfiguration information to a library holding section and copies it, FIG. 52 shows a state in which the library holding section copies the reconfiguration information and loads the reconfiguration information, FIG. 53 shows a state in which the library is unloaded and then reloaded, and FIG. 54 shows a state in which the library holding section deletes the reconfiguration information; and

FIG. 55 is a flow chart of a process of determining the number of parallel processes in a processing element.

### DETAILED DESCRIPTION OF THE INVENTION

In the following, embodiments of the distributed processing system according to the present invention will be described in detail with reference to the accompanying drawings. It should be understood that this invention is not limited to the embodiments.

In the following description, a JPEG decoding process will be discussed as an application executed by the distributed processing system according to the embodiment. However, the invention can be applied to processes other than the JPEG decoding process.

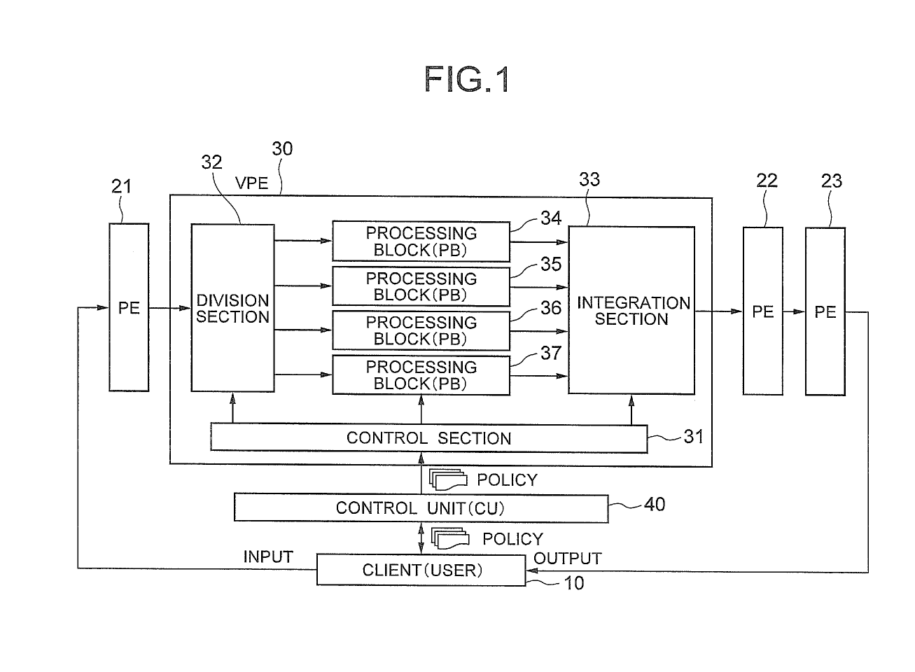

FIG. 1 schematically shows the configuration of a distributed processing system according to an embodiment of the present invention.

The distributed processing system according to the embodiment has a parallel processing virtualization processing element (VPE) 30, which is a computation module capable of parallel processing. The VPE 30 has a single input stream and/or a single output stream as an input/output interface to/from processing elements (PE) 21, 22, and 23 as external devices. A client 10 makes a request for execution of an application to a control unit (CU) 40.

The VPE 30 has a control section 31, a division section 32, an integration section 33, and one or more processing blocks (PB) 34, 35, 36, 37 in it.

In the case shown in FIG. 1, four processing blocks are used. However, the number of the processing blocks can be set arbitrarily, as will be described later.

The control section (processing block control section) calculates the number of parallel processes according to a policy (an index for controlling the number of parallel processes) given by the control unit. The control section controls the data stream division section or the data stream integration section in accordance with the calculated number of parallel processes to divide the input stream (i.e. data input to the processing blocks) or integrate the output stream (i.e. data output from the processing blocks).

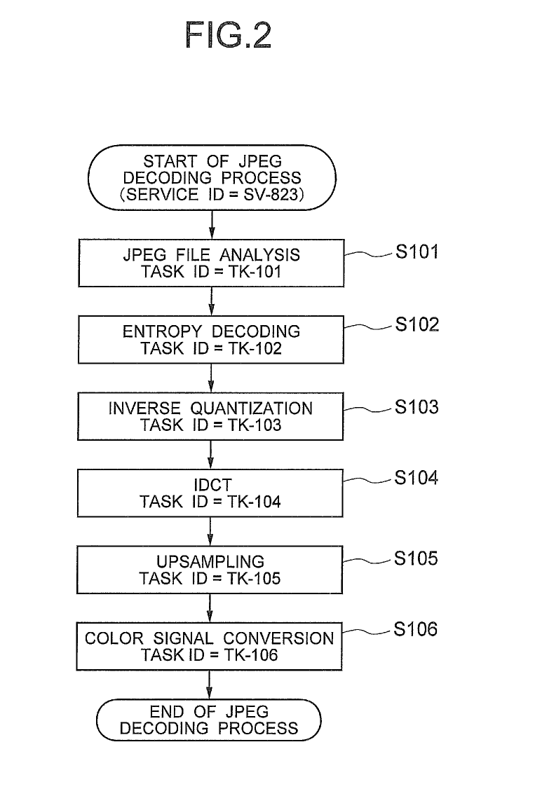

In the following, an example of execution of an application will be described with reference to FIG. 2. FIG. 2 is a flow chart of the process of the application in the embodiment.

As shown in FIG. 2, the JPEG decoding process can be divided into six sequential processes, which includes JPEG file analysis (step S101), entropy decoding (step S102), inverse quantization (step S103), IDCT (step S104), upsampling (step S105), and color signal conversion (step S106).

An application, such as the JPEG decoding process, requested by a user to be executed will be referred to as a “service”. A sub-process, such as the entropy decoding, that constitutes a part of the JPEG decoding process, will be referred to as a “task”. In other words, tasks are one or more unit processes that constitute an application.

A unique service ID and a unique task ID are assigned to each service and each task respectively in order to identify the content of their processing. In the case discussed herein, the service ID of the JPEG decoding process is SV-823 and the task IDs of the tasks that constitute the JPEG decoding process are TK-101 to TK-106.

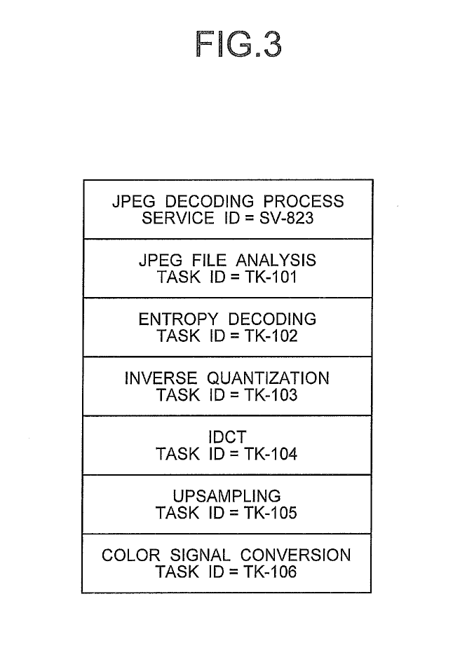

When a request for execution of the JPEG decoding process as a service is made by the client 10, the control unit 40 divides the JPEG decoding process, for example, into a series of tasks TK-101 to TK-106 in accordance with a service-task correspondence table shown in FIG. 3. FIG. 3 is a table stating the correspondence between the service shown in FIG. 2 and the tasks that constitute the service.

The tasks are assigned to the processing elements that can execute the respective tasks. The processing elements to which the tasks are assigned include the processing elements PE21, 2E22, and PE23 and the VPE 30.

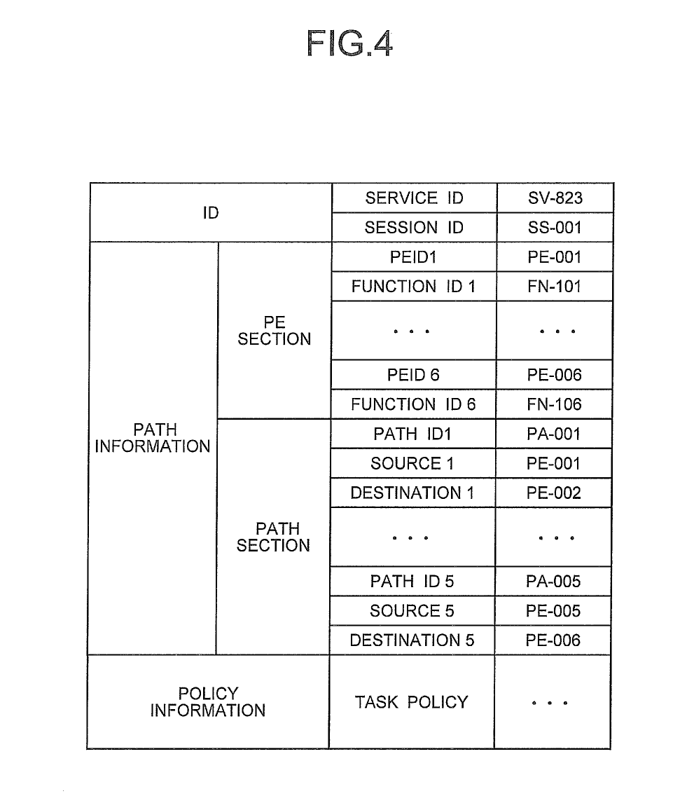

A path between processing elements has a unique pair of input and output, to which an ID or a path ID that identifies the path is assigned. The control unit 40 generates information on the configuration of the processing path (or execution transition information). An example of the execution transition information is shown in FIG. 4. FIG. 4 is a table showing exemplary items of information constituting the execution transition information and exemplary data of the respective items of the information.

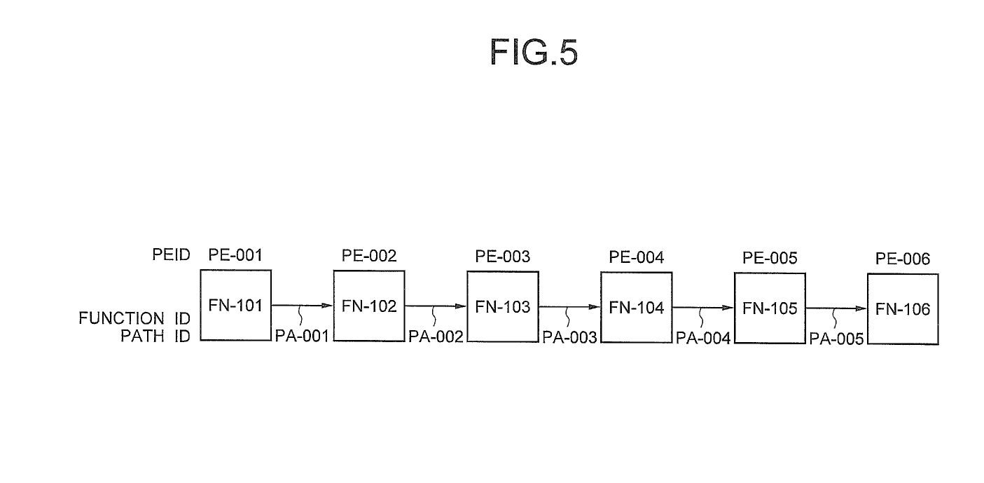

For example, the processing path in performing the JPEG decoding may be configured in a manner shown in FIG. 5 in accordance with the execution transition information shown in FIG. 4. FIG. 5 shows an exemplary system model corresponding to the configuration specified by the execution transition information shown in FIG. 4.

After the execution transition information is created, allocation of computational resources necessary for the process and allocation of processing paths are performed.

The execution transition information in this embodiment includes a task policy. Policies are restrictions placed on the execution of the entire service and the execution of the tasks in the processing elements including the parallel processing virtualization processing element (VPE). Policies include a service policy (which is criteria concerning the execution of an application) that restricts the execution of the entire service and a task policy (which is an index for controlling the number of parallel processes) that restricts the execution of the task in each processing element. For example, it is possible to directly specify the multiplicity of the parallel processes (i.e. the number of parallel processes) for each task using a task policy. Furthermore, it is also possible that the processing time of the entire service is specified as a performance index using a service policy, the control unit optimizes the processing paths in order to complete the process in the specified processing time to automatically determine the number of parallel processes of the task execution in the processing elements, thereby automatically generating a task policy. In any case, the task policy that regulates the task execution in the processing elements, is determined eventually and notified to the processing elements.

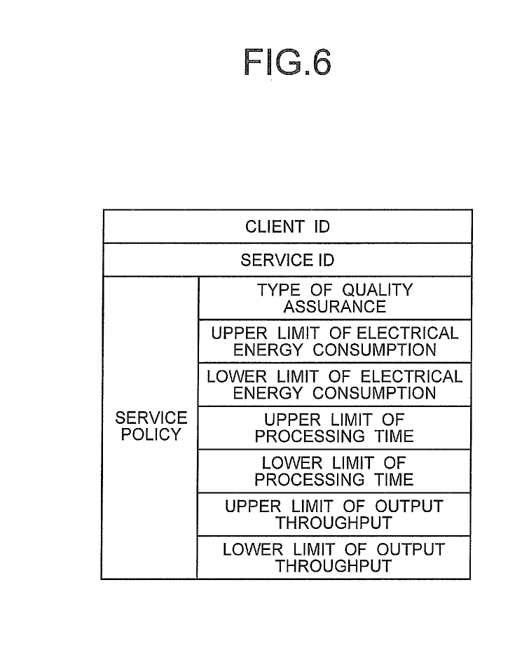

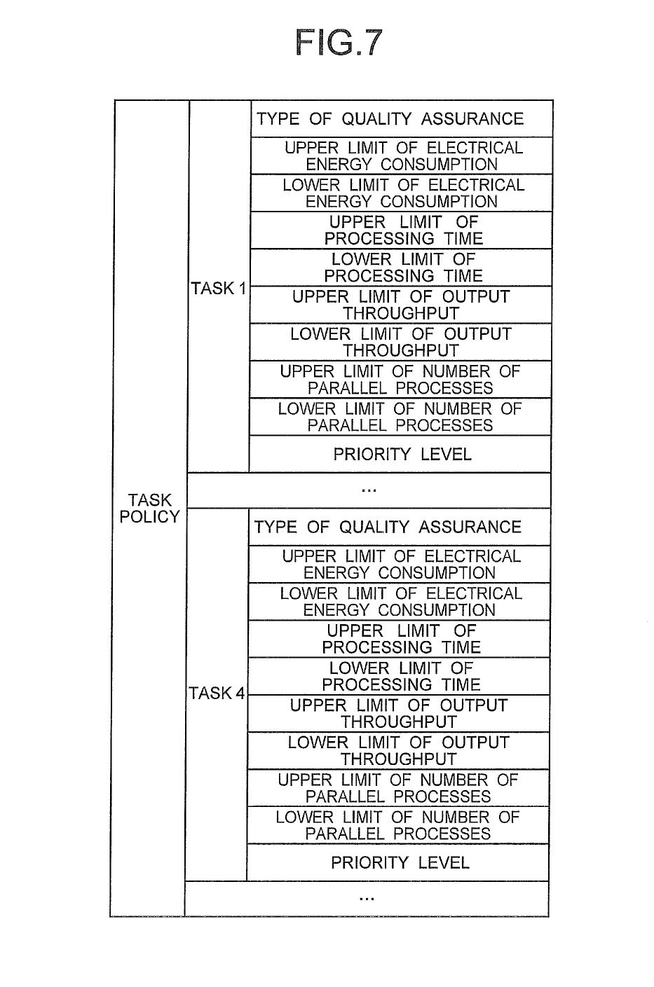

Now, examples of parameters that can be used in the service policy and the task policy will be described. Table 1 shows parameters contained in the policy. FIG. 6 is a table showing an exemplary configuration of the service policy according to the embodiment. FIG. 7 is a table showing an exemplary configuration of the task policy according to the embodiment. In Table 1, the parameters that can be specified in the respective policies are marked with circles (O).

TABLE 1

| | Service | Task | |
|---|---|---|---|
| Parameter | Policy | policy | Description |
| type of | ◯ | ◯ | To select either the guarantee |
| quality | | | type in which a process needs to |
| assurance | | | be performed within limit values |
| | | | or the best effort type in which |
| | | | a process is performed using |
| | | | allocatable resources with |
| | | | performance closest to |
| | | | requirements. |
| | | | In embodiments, in cases where |
| | | | the guarantee type is selected |
| | | | in the service policy, the |
| | | | control unit determines whether |
| | | | or not the service policy is |
| | | | applicable. If the conditions |
| | | | of the specified service policy |
| | | | are not satisfied, the control |
| | | | unit returns an error or |
| | | | presents an alternative plan. |
| | | | In cases where the best effort |
| | | | type is selected in the service |
| | | | policy, the control unit |
| | | | determines a task policy |
| | | | automatically and proceeds with |
| | | | the execution of tasks even if |
| | | | there is an unsatisfied |
| | | | condition(s). |
| electric | ◯ | ◯ | To specify the upper and lower |
| energy | | | limits of electrical energy |
| consumption | | | consumption needed for the task |
| | | | processing specified by a user |
| | | | (client). If not specified, |
| | | | this parameter is set to 0. It |
| | | | is not necessary to specify both |
| | | | the upper and lower limits. |
| processing | ◯ | ◯ | If a process is to be completed |
| time | | | in a limited time, the upper |
| | | | limit of the processing time is |
| | | | specified. If a process is to be |
| | | | performed as slowly as possible |
| | | | so that the process continues |
| | | | until the time limit, the lower |
| | | | limit of processing time is |
| | | | specified. |
| output | ◯ | ◯ | To specify the upper and lower |
| throughput | | | limits of output throughput of |
| | | | the entire system and processing |
| | | | elements. |
| number of | | ◯ | The number of parallel processes |
| parallel | | | in each processing element. In |
| processes | | | some cases, the number of |
| | | | parallel processes in the VPE is |
| | | | specified to be 2 (two) or more. |
| | | | If parallel processing is not |
| | | | desired, the number of parallel |
| | | | processes of the VPE is |
| | | | specified to be 1 (one). This |
| | | | parameter is not applied to the |
| | | | entire system. |
| priority | | ◯ | Level of priority of service |
| level | | | processing in each processing |
| | | | element. In the embodiments, |
| | | | it is represented by high, |
| | | | middle, and low by way of |
| | | | example. |

Examples of the service policy include the type of, quality assurance, upper and lower limits of electrical energy consumption, upper and lower limits of processing time, and upper and lower limits of output throughput, as shown in FIG. 6. Examples of the task policies include the type of quality assurance, upper and lower limits of electrical energy consumption, upper and lower limits of processing time, upper and lower limits of output throughput, upper and lower limits of the number of parallel processes, and priority level, as shown in FIG. 7.

The service policy is registered in the control unit with an ID for identifying the client before a service execution request is made by the client. In connection with this, if the service(s) to which the service policy is applied is (are) to be designated, the service(s) should be registered in the control unit with the service ID(s). If the service(s) to which the service policy is applied is (are) not to be designated, the registered service policy is applied to all the services requested by the client, and the execution transition information including the task policy is created.

The task policy is created at the time of creating the execution transition information regardless of whether or not the service policy is registered. The parameters of the task policy may include choices to be chosen by the client. The control unit may determine the most appropriate task policy and use it without consent of the client.

### EMBODIMENTS

In the following, embodiments of the distributed processing system according to the above mode will be described. In the following description, the characteristic configurations, operations, and effects will be mainly discussed, and the configurations, operations, and effects that have already been described will not be described in some cases. The number of the processing elements arranged antecedent and subsequent to the VPE may be different from those in the case shown in FIG. 1, in accordance with the content of the embodiments.

In the following embodiments, the processing elements are basically assumed to be implemented as software. However, the processing elements may be implemented as hardware. The outline of the latter case will be described later.

### First Embodiment

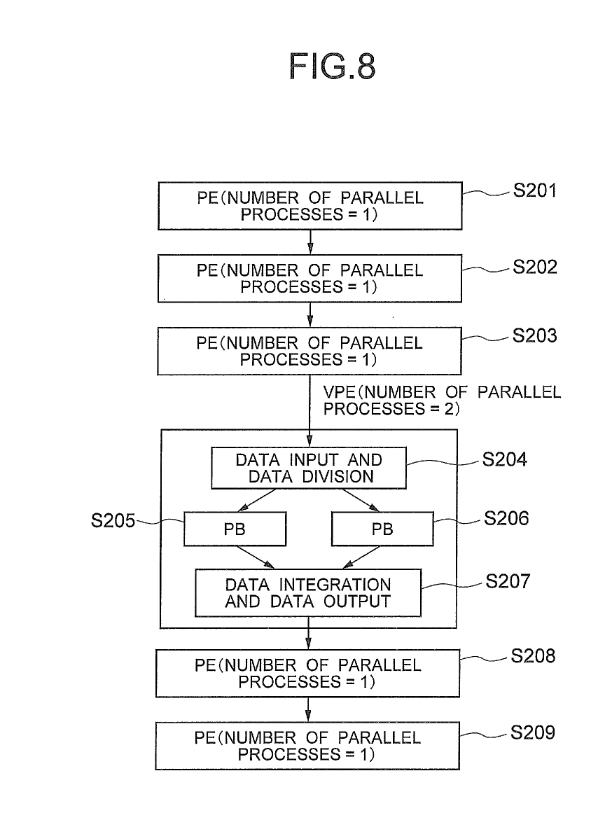

A first embodiment relates to processing in a case in which the client specifies the task policy. FIG. 8 is a flow chart showing the process of the application according to the first embodiment, and the steps in the flow chart correspond to the steps shown in FIG. 2 as follows. In this embodiment, the client specifies the number of parallel processes for each of the processing elements for the task policy created by the control unit CU, and the number of parallel processes of the IDCT (task ID=TK-104) is specified as 2.

Among the processes shown in FIG. 2, the JPEG file analysis (step S101) corresponds to a process in the processing element PE1 (step S201) in which the number of parallel processes is equal to 1, the entropy decoding (step S102) corresponds to a process in the processing element PE2 (step S202) in which the number of parallel processes is equal to 1, and the inverse quantization (step S103) corresponds to a process in the processing element PE3 (step S203) in which the number of parallel processes is equal to 1.

The IDCT (step S104) corresponds to input of data to be processed to the VPE (PE4) in which the number of parallel processes is equal to 2, division of data (step S204), a process in two processing blocks (PB) in the VPE (steps S205 and S206), integration of the processed data in the two processing blocks, and output of the data (step S207).

The upsampling (step S105) corresponds to a process in the processing element PE5 (step S208) in which the number of parallel processes is equal to 1, and the color signal conversion (step S106) corresponds to a process in the processing element PE6 (step S209) in which the number of parallel processes is equal to 1. Thus, the JPEG decoding process can be divided into sequential processes of steps S201 to S209 as with steps S101 to S106 shown in FIG. 2.

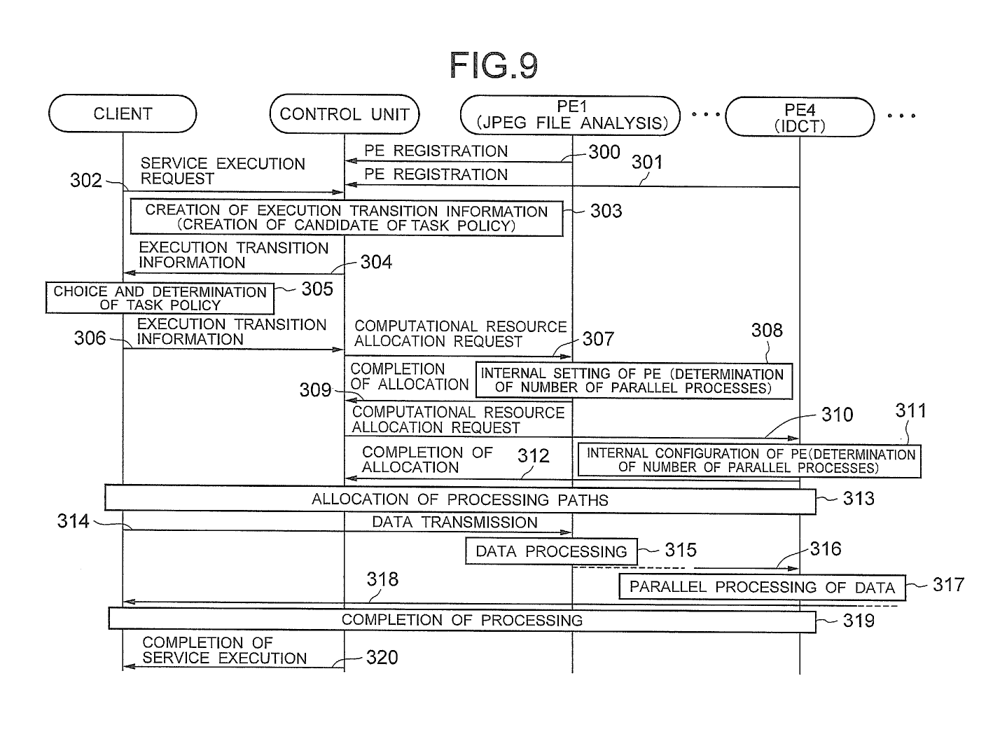

In the following, the sequence according to the first embodiment will be described. FIG. 9 is a chart showing the sequence of the execution of the service in the first embodiment.

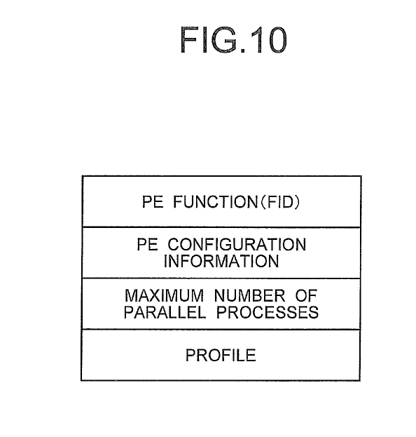

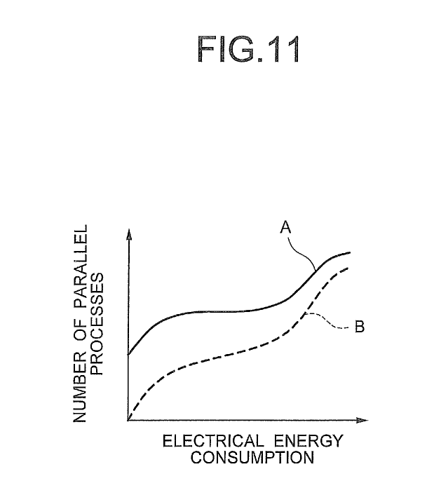

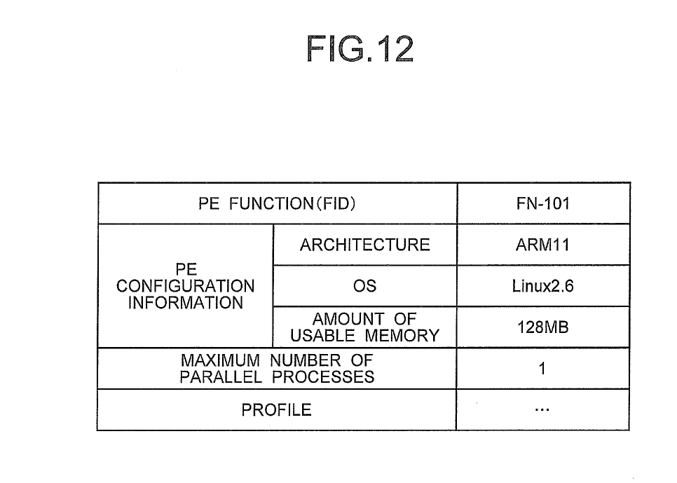

In step 300 of the sequence, the processing element PE1 sends PE (processing element) registration information shown in FIG. 10 to the control unit at the time of start-up. FIG. 10 is a table showing exemplary PE registration information in the first embodiment. Table 2 shows the data fields of the PE registration information shown in FIG. 10. FIG. 11 is a graph showing an exemplary profile shown in FIG. 10. FIG. 12 is a table showing an example of the PE registration information shown in FIG. 10 for the processing element PE1. In FIG. 11, the solid line A represents the change in the upper limit of the number of parallel processes relative to the electrical energy consumption, and the broken line B represents the change in the lower limit of the number of parallel processes relative to the electrical energy consumption.

TABLE 2

| data field | description |
|---|---|
| PE function ID (FID) | ID number representing the |
| | function of the processing |
| | element. FID corresponds to |
| | task ID. For example, the |
| | function of a processing |
| | element that can execute a task |
| | having a task ID of TK-101 is |
| | represent by an FID of FN-101. |
| PE configuration information | Information on specifications |
| | of the processing element, |
| | including the operating |
| | frequency and memory capacity |
| | etc. |
| maximum number of parallel | The maximum number of tasks |
| processes | that can be executed at the same |
| | time. |
| profile | Characteristics values |
| | inherent to the processing |
| | element, in particular a |
| | function between upper and |
| | lower limits of the number of |
| | parallel processes and other |
| | parameters of the task policy |
| | such as the electrical energy |
| | consumption. For example, |
| | characteristics between the |
| | number of parallel processes |
| | and the electrical energy |
| | consumption, and the number of |
| | parallel processes and the |
| | output throughput. |

Here, the processing element PE1 can provide the function having an FID of FN-101 (JPEG file analysis) with the maximum number of parallel processes equal to 1, which means that the processing element PE1 is not capable of parallel processing.

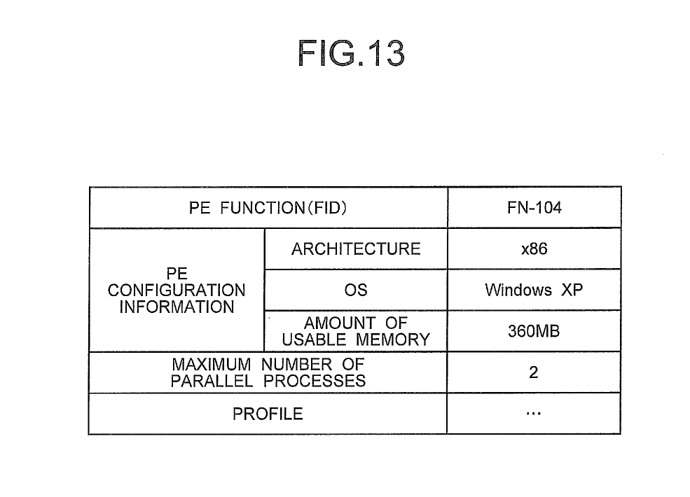

In step 301 of the sequence, the VPE serving as the processing element PE4 sends the PE registration information shown in FIG. 13 to the control unit at the time of start-up as with the processing element PE1. FIG. 13 is a table showing an example of the PE registration information of the processing element PE4 according to the first embodiment.

The processing element PE4 (VPE) can provide the function having an FID of FN-104 (IDCT) with the maximum number of parallel processes equal to 2. Though not shown in the drawings, the other processing elements also send their PE registration information at the time of start-up to register themselves to the control unit CU.

In step 302 of the sequence, the client makes a request for execution of the JPEG decoding, as a service execution request, to the control unit with designation of a service ID of SV-823.

In step 303 of the sequence, the control unit creates execution transition information based on the registration information of the processing elements. The control unit may keep monitoring the dynamically changing PE registration information among the registration information of the processing elements and reflect the monitoring result on the created execution transition information.

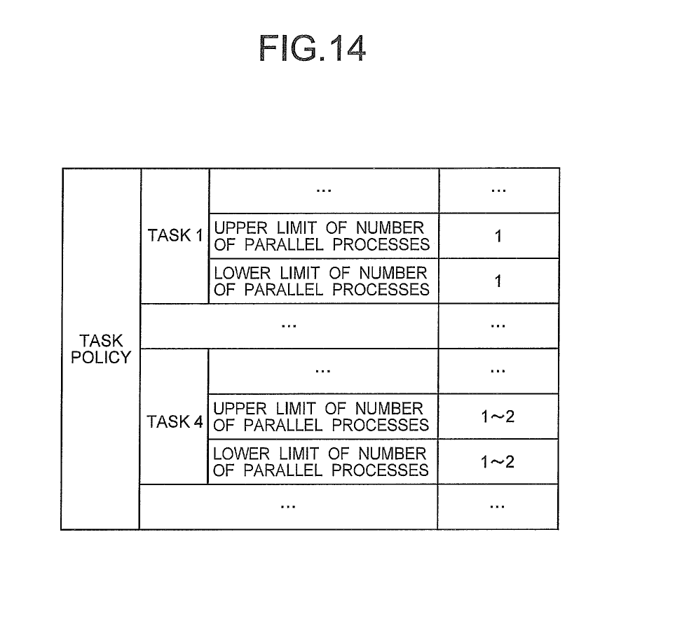

It is assumed that the execution transition information containing the path information same as that shown in FIG. 4 is created as a result, and candidate values for the respective parameters of the task policy are determined based on the registration state of the processing elements. As candidate values, the upper and lower limits of the number of parallel processes shown in FIG. 14 are presented. FIG. 14 is a table showing an example of the presentation of choices in the task policy according to the first embodiment. Here, it is assumed that the candidate values for the other parameters such as the electrical energy consumption are determined.

In step 304 of the sequence, the control unit sends the execution transition information including the task policy to the client. In step 305 of the sequence, the client chooses a certain value (task policy) for the parameters for which a range of the value is presented. Here, the policy that allows choice is only the upper and lower limits of the number of parallel processes. It is assumed that the other policies are inherent to each processing element, and the client cannot specify the values for them. If the combination of the values of the policies is improper or impossible, it is checked on the GUI (fifth embodiment), or the control unit checks it and returns an error.

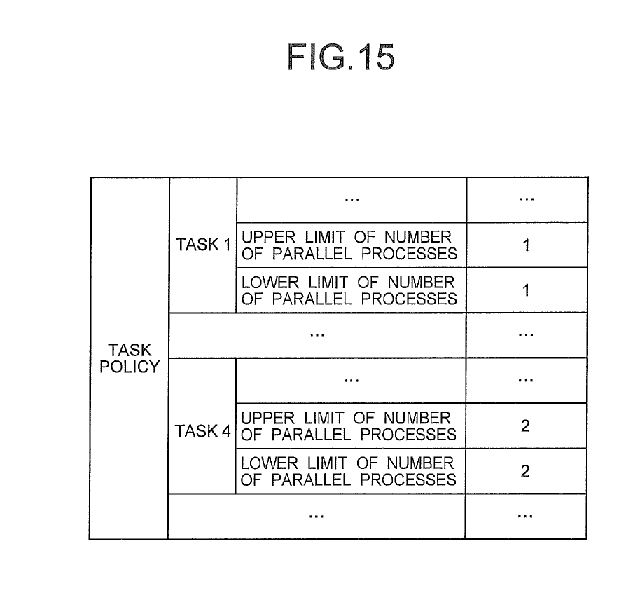

Here, it is assumed that the client determines, in step 305 of the sequence, the values of the parameters as shown in FIG. 15, by choosing or designating them from among the candidate values. In this case, the upper and lower limits of the number of parallel processes have the same value. Thus, the number of parallel processes of the processing element PE1 is determined to be 1, and the number of parallel processes of the processing element PE4 is determined to be 2. FIG. 15 is a table showing an example of the task policy after the determination by the client according to the first embodiment.

In step 306 of the sequence, the client transmits the execution transition information containing the chosen task policy to the control unit CU.

Then, the control unit sends the execution transition information containing the task policy to the processing elements designated in the execution transition information, thereby requesting allocation of computational resources. In step 307 of the sequence, the control unit CU sends the execution transition information to the processing element PE1 and requests allocation of the computational resources.

Before sending the execution transition information to the processing elements PE, the control unit checks the values of the parameters and the combination of the values of the parameters. If the values and/or the combination are improper or impossible, the control unit returns an error and terminates the processing of the service.

In step 308 of the sequence, upon receiving the execution transition information, the processing element PE1 recognizes the assigned task and allocates the computational resources such as memory necessary for the task execution. The processing element PE1 applies the task policy and changes the internal configuration of itself as needed. In the first embodiment, the processing element PE1 recognizes that both the upper and lower limits of the number of parallel processes are equal to 1 and determines the number of parallel processes as 1. If the processing element PE1 has no processing block, the processing element PE1 newly creates a process or a thread, or loads program information. If the processing element PE1 is implemented as hardware, the processing element PE1 performs dynamic reconfiguration such as switching as needed.

In step 309 of the sequence, after allocating the computational resources and applying the policy, the processing element PE1 notifies the control unit of completion of the computational resource allocation.

In step 310 of the sequence, the processing element PE4 receives the computational resource allocation request from the control unit as with the processing element PE1.

In step 311 of the sequence, the processing element PE4 recognizes that both the upper and lower limits of the number of parallel processes are equal to 2 and determines the number of parallel processes as 2. If the processing element PE4 does not have two processing blocks, the processing element PE4 newly creates a process(es) or a thread(s), or loads program information. If there is unnecessary processing block, it may be deleted. If the processing element PE4 is implemented as hardware, the processing element PE4 performs dynamic reconfiguration such as switching of the path to a processing block(s) as needed.

In step 312 of the sequence, after allocating the computational resources and applying the policy, the processing element PE4 notifies the control unit of completion of the computational resource allocation.

The processing elements other than the processing elements PE1 and PE4 also perform allocation of computational resources.

After verifying the completions of the computational resource allocation by all the processing elements designated in the execution transition information, the control unit makes a request to the respective processing elements for allocation of processing paths between the processing elements (step 313 of the sequence). Each processing element allocates processing paths with the adjacent processing elements. Then, the control unit makes a request to the client for connection to the processing elements, thereby notifying the client that the processing of the service can be started.

In step 314 of the sequence, after the processing paths between the processing elements have been allocated, the client transmits data. The processing elements perform data flow processing along the allocated processing paths. In this case, the client transmits the data to the processing element PE1, and the processing element PE1 processes the data and transmits the processed data to the processing element PE2. Similarly, the processing elements PE2 to PE5 receive data from the respective antecedent processing elements and transmit the processed data to the respective subsequent processing elements, and the processing element PE6 outputs the result.

In step 315 of the sequence, the processing element PE1 receives the data from the client, retrieves a JPEG file, and analyzes the header. The processing element PE1 transmits the retrieved image information to the processing element PE2.

In step 316 of the sequence, after the processing element PE2 performs entropy decoding, the processing element PE3 receives the data from the processing element PE2 and performs inverse quantization, and the processing element PE4 receives the data from the processing element PE3.

In step 317 of the sequence, the processing element PE4 performs IDCT by parallel processes. For example, if the processing element PE4 performs the processes on a MCU (Minimum Coded Unit)-by-MCU basis and sequential and unique numbers are assigned to the MCUs in accordance with the coordinate values in an image, the division section divides the MCUs into the MCUs having even numbers and the MCUs having odd numbers in order to process them in different processing blocks in parallel, and the integration section reintegrates the data by performing synchronizing processing before transmitting the data to the next processing element PE5.

In step 318 of the sequence, after the processing element PE5 performs upsampling, the processing element PE6 performs color signal conversion and returns the result data to the client, and the processing of the service is terminated.

In step 319 of the sequence, the processing paths and the computational resources are deallocated, and then the completion processing is executed.

In step 320 of the sequence, the control unit sends a notification of completion of service execution to the client, and terminates execution of the service.

In second to seventh embodiments, it is assumed that the computational resource allocation in steps 307 to 309 and steps 310 to 312 in the above-described sequences is performed appropriately in all the processing elements necessary for the execution of the service, unless specifically stated otherwise. The processes from the computational resource allocation (step 313) to the completion of service execution (step 320) are performed in the same manner in all the embodiments, and detailed descriptions of these processes will be eliminated in some cases by simply describing “the execution of the service is continued” or the like.

### Second Embodiment

A second embodiment relates to a processing in the case in which a client specifies the service policy as a best effort type quality assurance.

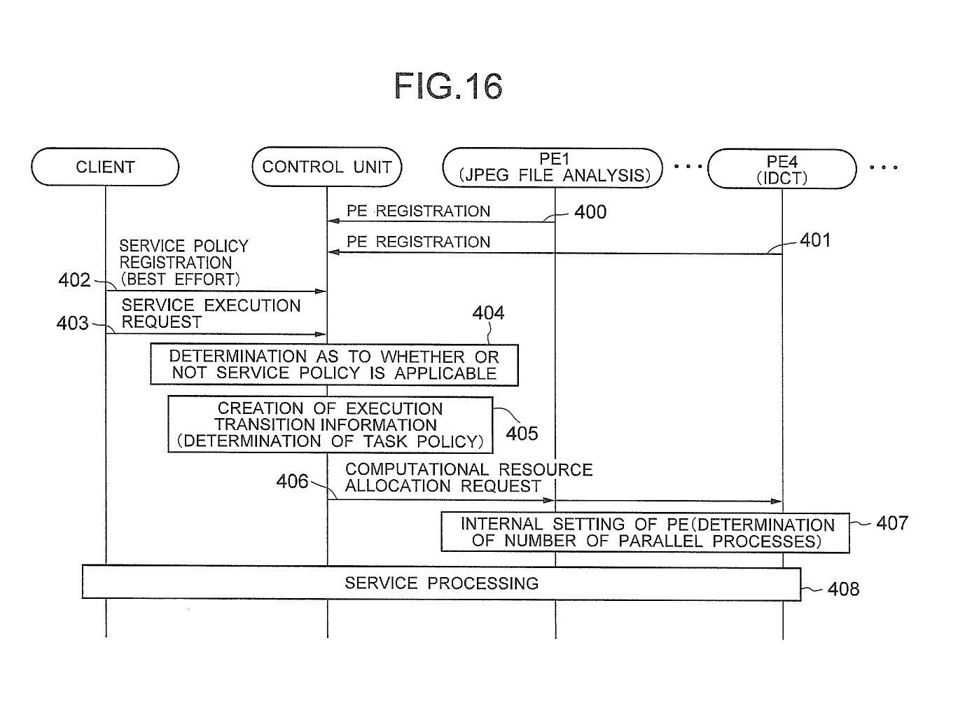

FIG. 16 is a chart showing a sequence of the execution of the service in the second embodiment.

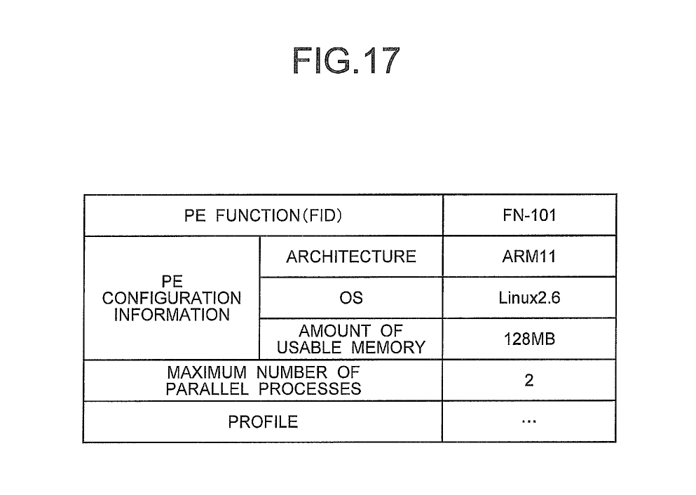

In step 400 of the sequence, the processing element PE1 sends the PE registration information shown in FIG. 17 to the control unit at the time of start-up to notify that the processing element PE1 can execute a task with the number of parallel processes equal to 2. FIG. 17 is a table showing an example of the PE registration information of the processing element PE1 in the second embodiment.

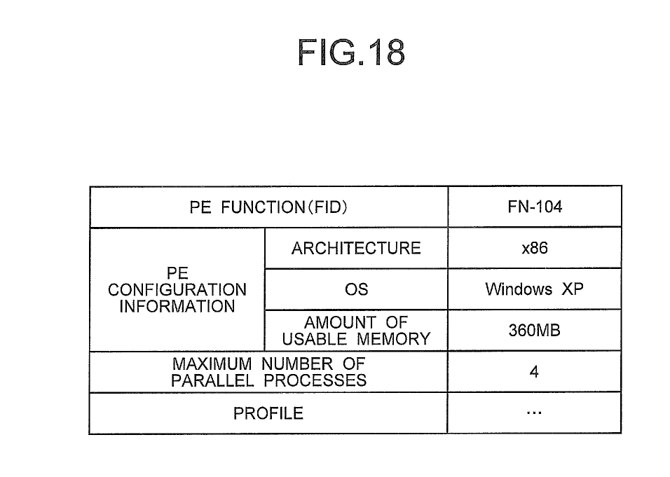

In step 401 of the sequence, as with the processing element PE1, the processing element PE4 (VPE) sends the PE registration information (shown in FIG. 18) to the control unit to notify that the processing element PE4 can execute a task with the number of parallel processes equal to 4. The processing elements other than the processing elements PE1 and PE4 also send their PE registration information to the control unit to register their information at the time of start-up. FIG. 18 is a table showing an example of the registration information of the processing element PE4 in the second embodiment.

In step 402 of the sequence, the client registers the policy to be applied to the service to the control unit together with its own client ID. This policy may be applied to all the services or only to a specific service(s) by specifying a service ID(s).

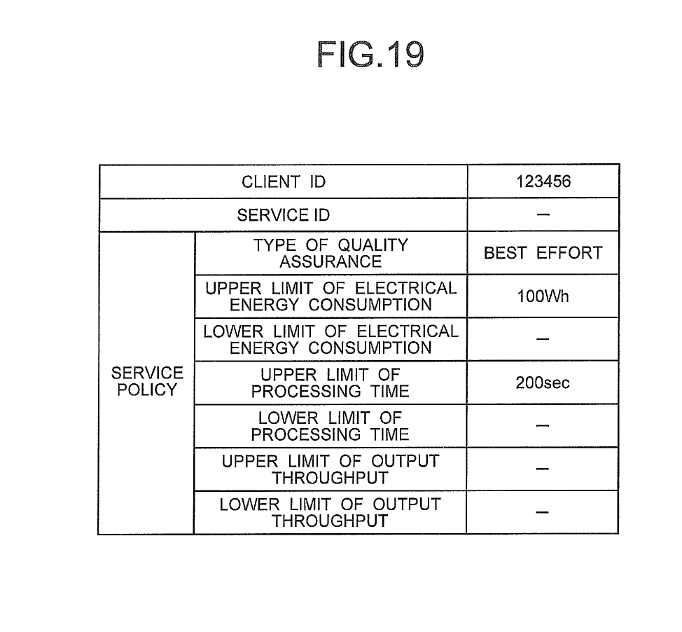

In the second embodiment, the service ID is not specified, and the service policy shown in FIG. 19 is applied to the entire system for all the services requested by the client that is identified by a client ID of 123456. FIG. 19 is a table showing an example of the service policy specified by the client in the second embodiment.

In step 403 of the sequence, the client makes a request for execution of the JPEG decoding, as a service execution request, to the control unit with designation of a service ID of SV-823.

In step 404 of the sequence, upon receiving the service execution request, the control unit determines whether or not the service policy is applicable and a task policy can be determined. In the second embodiment, since the quality assurance type in the service policy is the best effort type, the control unit can automatically determine the task policy and proceed with the task execution even if a condition(s) such as electrical energy consumption is (are) not satisfied.

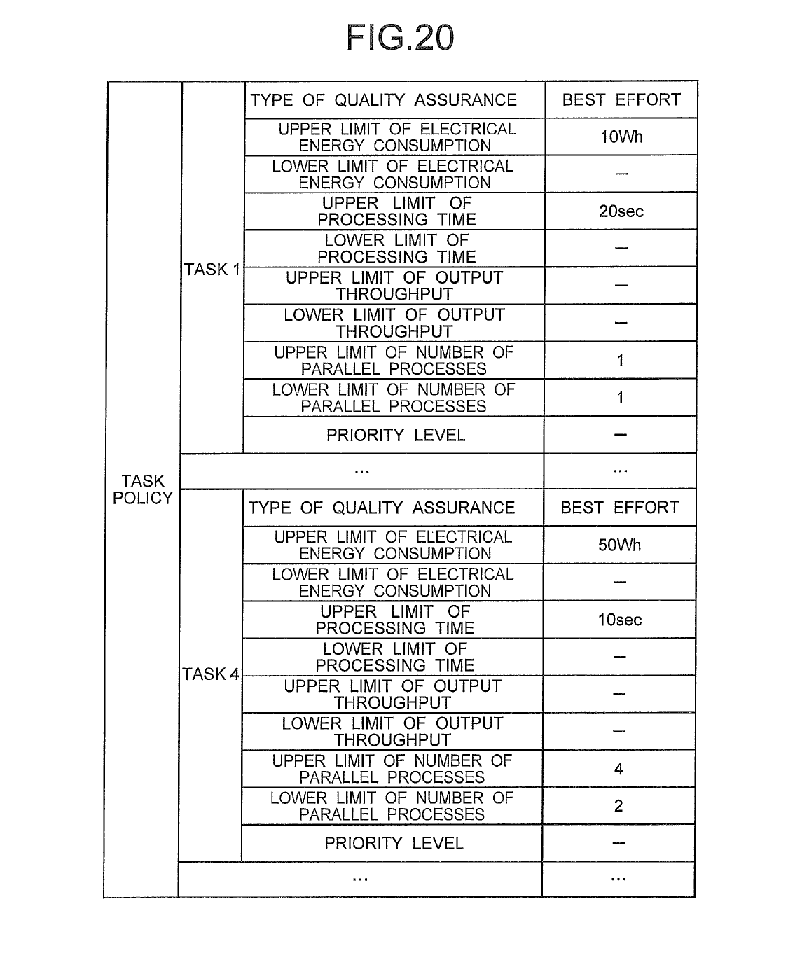

In step 405 of the sequence, the control unit determines the task policy based on the PE registration information and creates execution transition information. The control unit may keep monitoring the dynamically changing PE registration information among the PE registration information and reflect the monitoring result on the created execution transition information. As a result, the control unit creates the execution transition information that is the same as the execution transition information shown in FIG. 4. In this case, the control unit determines the parameters of the policy information for the processing elements as shown in FIG. 20 in such a way that the policy specified by the client is satisfied. FIG. 20 is a table showing an example of the task policy determined based on the service policy in the second embodiment.

In step 406 of the sequence, the control unit transmits the execution transition information containing the created task policy to the processing elements designated in the execution transition information, thereby requesting allocation of computational resources.

In step 407 of the sequence, upon receiving the execution transition information, the processing elements recognize the assigned tasks and allocate computational resources such as memory necessary for the task execution. The processing elements apply the task policy and change the internal configuration of themselves as needed.

In the second embodiment, if a processing element does not have processing blocks as many as the number of the parallel processes, the processing element newly creates a process(es) or a thread(s), or loads program information. If the processing element is implemented as hardware, the processing element performs dynamic reconfiguration such as switching as needed. Since the upper limit and the lower limit of the number of parallel processes are different from each other in the task policy of the task 4 shown in FIG. 20, the number of parallel processes is dynamically determined in the VPE in such a way that the conditions concerning the other parameters such as the electrical energy consumption are satisfied, when data processing is controlled. The number of parallel processes in a processing element is determined, for example, by a process in an embodiment that will be described later.

In step 408 of the sequence, the control unit receives notification of the completion of computational resource allocation from the processing elements, allocates the processing paths, and proceeds with the processing of the service.

### Third Embodiment

A third embodiment relates to a processing in the case in which although the client specifies the service policy as a guarantee type quality assurance, the service policy specified by the client is not applicable.

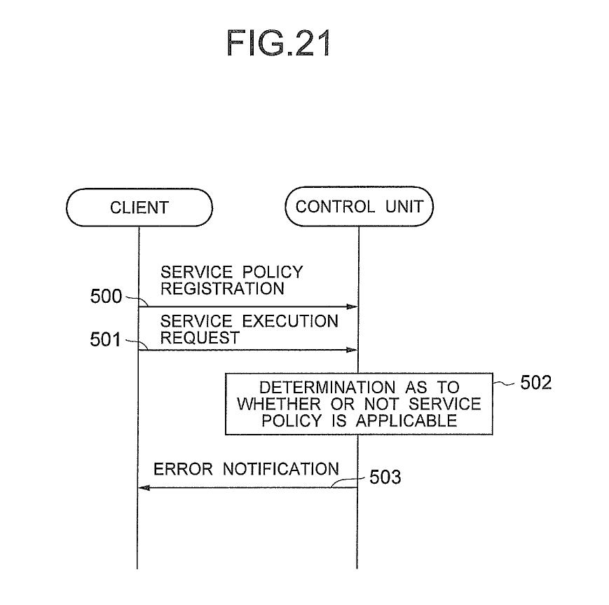

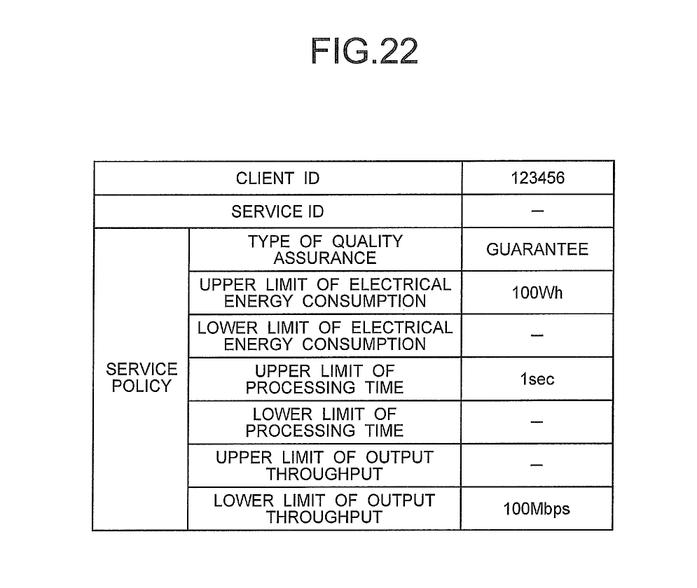

FIG. 21 is a chart showing a sequence of the execution of the service in the third embodiment. FIG. 22 is a table showing an example of the service policy registered by the client in the third embodiment.

In step 500 of the sequence, the client registers the service policy shown in FIG. 22 to the system. It is assumed that the registration of the processing elements has been completed before step 500 of the sequence.

In step 501 of the sequence, the client makes a request to the control unit for execution of the service with designation of the ID of the requested service.

In step 502 of the sequence, the control unit determines whether or not the service policy registered in advance by the client is applicable. In the case of the third embodiment, the control unit determines that the service policy is not applicable.

In step 503 of the sequence, the control unit returns an error to the client and terminates the processing of the service.

In the third embodiment, since the selected quality assurance type is the guarantee type, if the quality is not assured, the control unit terminates the execution of the service and returns an error because of the contradiction to the client's intent.

The following fourth and fifth embodiments relate to procedures followed by the distributed processing system if it is determined in step 502 of the sequence in FIG. 21 that the service policy is not applicable. If the service policy is not applicable, the system can return an error or take one of the following measures:

(1) presenting an alternative service policy (fourth embodiment); and
(2) restricting or checking the entry of task policy on the GUI of the client (fifth embodiment).

In the following, the fourth and fifth embodiments will be described.

### Fourth Embodiment

The fourth embodiment relates to the presentation of an alternative service policy among the measures taken by the distributed processing system when it is determined that the service policy is not applicable.

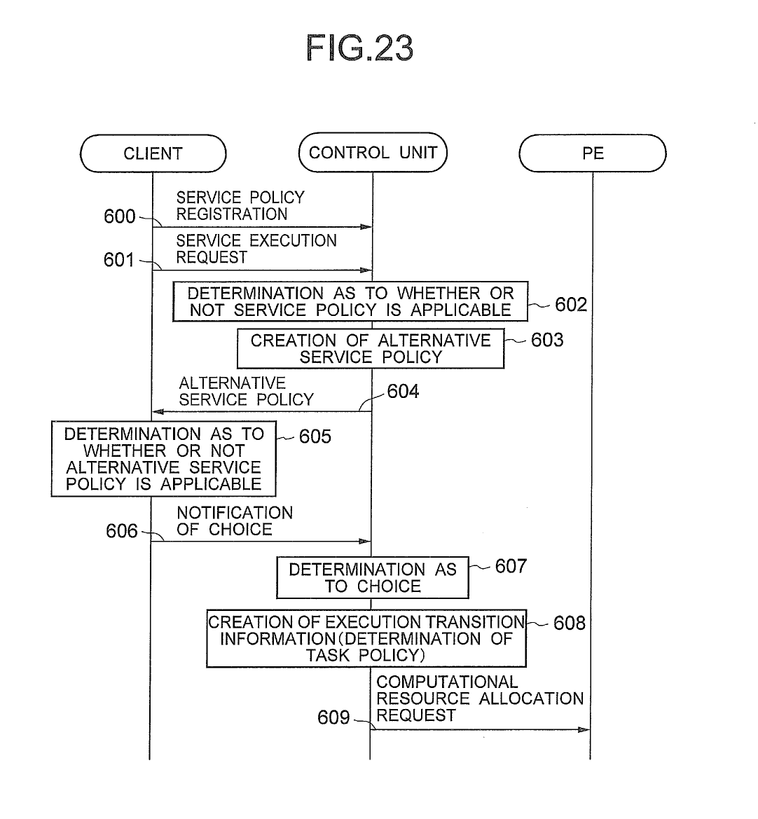

FIG. 23 is a chart showing a sequence of the execution of the service in the case in which the control unit presents alternatives in the fourth embodiment.

First, in step 600 of the sequence, it is assumed that the registration of the processing elements has been completed. The client has registered in advance the service policy same as that in step 500 of the sequence in FIG. 21.

In step 601 of the sequence, the client makes a request to the control unit for execution of the service with the designation of the ID of the requested service.

In step 602 of the sequence, the control unit determines whether or not the service policy that is registered in advance by the client is applicable to the service. In the fourth embodiment, the control unit determines that the service policy is not applicable.

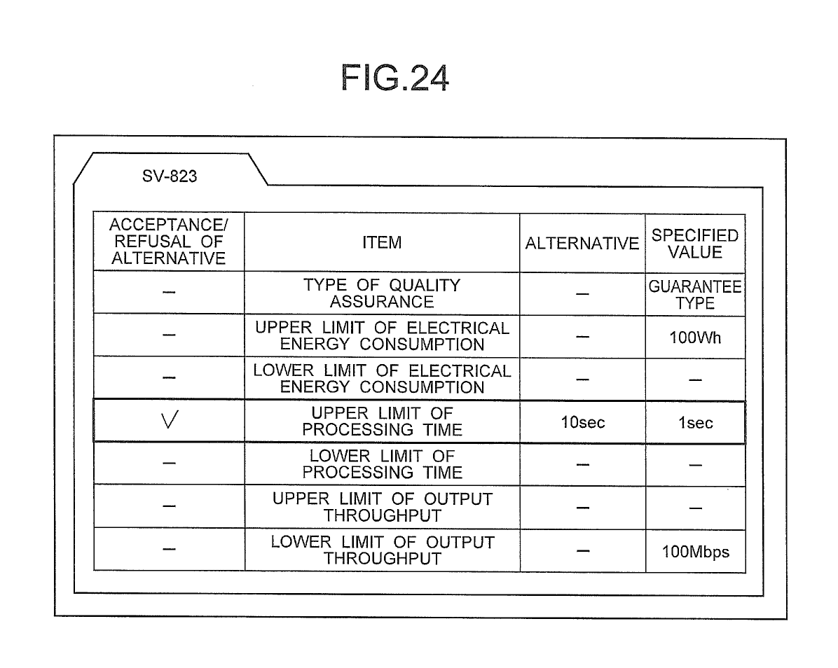

In step 603 of the sequence, the control unit creates an alternative service policy. The control unit presents the created service policy to the client (step 604). A graphical image of the presentation of the alternative policy displayed on the GUI of the client is shown in FIG. 24. FIG. 24 shows an example of the GUI (Graphical User Interface) window of the alternative service policy displayed on the client according to the fourth embodiment.

The example of the GUI shown in FIG. 24 allows the user (client) to edit the values of parameters of the service policy for the service having a service ID of SV-823. In the case shown in FIG. 24 according to the fourth embodiment, an upper limit of processing time of 10 seconds is presented as an alternative for easing the upper limit of 1 second specified by the client, in order to assure the upper limit of electrical energy consumption of the entire system and the upper limit of output throughput.

In step 605 of the sequence, the client makes a selection between acceptance and refusal of the alternative. In the fourth embodiment, the client accepts the alternative.

In step 606 of the sequence, the client transmits the result of the selection to the control unit. The control unit makes a determination as to whether or not the result of the selection is acceptable (step 607).

If the control unit accepts the result of the selection in step 607 of the sequence, the control unit determines the task policy and creates execution transition information (step 608). In step 609 of the sequence, the control unit transmits the execution transition information to the processing elements together with a computational resource allocation request.

On the other hand, if the control unit does not accept the result of the selection in step 607 of the sequence, the control unit returns an error to the client and terminates the execution of the service.

### Fifth Embodiment

The fifth embodiment relates to the restriction or check of the entry of task policy made on the GUI of the client among the measures taken by the distributed processing system when it is determined that the service policy is not applicable.

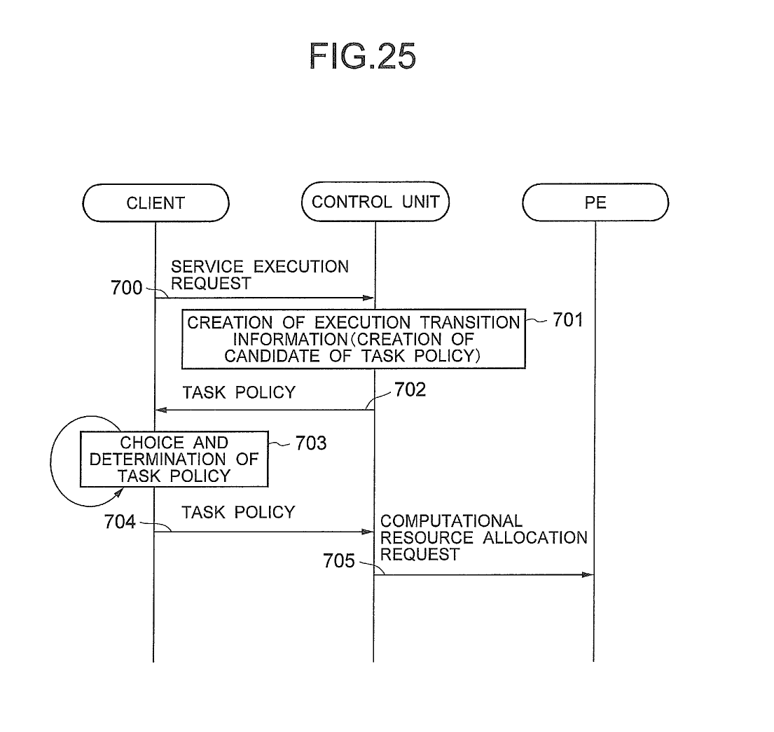

FIG. 25 is a chart showing a sequence of the execution of the service in the case in which the entry of task policy on the client is restricted according to the fifth embodiment.

In step 700 of the sequence, it is assumed that the registration of the processing elements has been completed. The client makes a request to the control unit for execution of the service with designation of the ID of the requesting service.

In step 701 of the sequence, the control unit creates an execution transition information including a candidate task policy.

In step 702 of the sequence, the control unit transmits the execution transition information, which contains choices of the values of parameters of the task policy, to the client. When transmitting the execution transition information, the control unit also transmits allowable combinations of the values of parameters of the task policy.

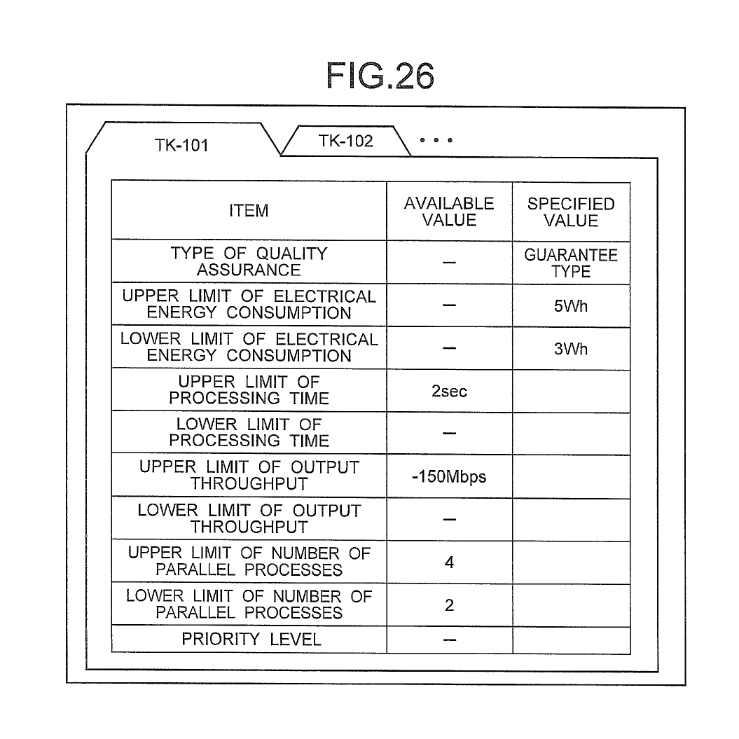

In step 703 of the sequence, when setting the parameters of the task policy, the client can set the value of the parameters of the task policy within the range of allowable values displayed on the GUI shown in FIG. 26. In this case, if the GUI determines, based on the allowable combinations of the values of parameters created in step 702 of the sequence, that a value exceeding the range of allowable values is set, the GUI returns an error, thereby restricting the entry. The value that has already been set is checked on a real time basis, and the allowable values are changed in accordance with the set value. By restricting or checking the entry of the values of parameters of the task policy on the GUI, the process of checking the policy in the control unit can be skipped. FIG. 26 shows an exemplary case of the restriction of the entry on the GUI window on the client according to the fifth embodiment.

In step 704 of the sequence, after determining the task policy, the client sends the task policy to the control unit.

In step 705 of the sequence, the control unit configures execution transition information based on the determined task policy and starts allocation of computational resources necessary for the execution of the service.

### Sixth Embodiment

A sixth embodiment relates to a process of specifying the policy by designating a priority level for each of the tasks.

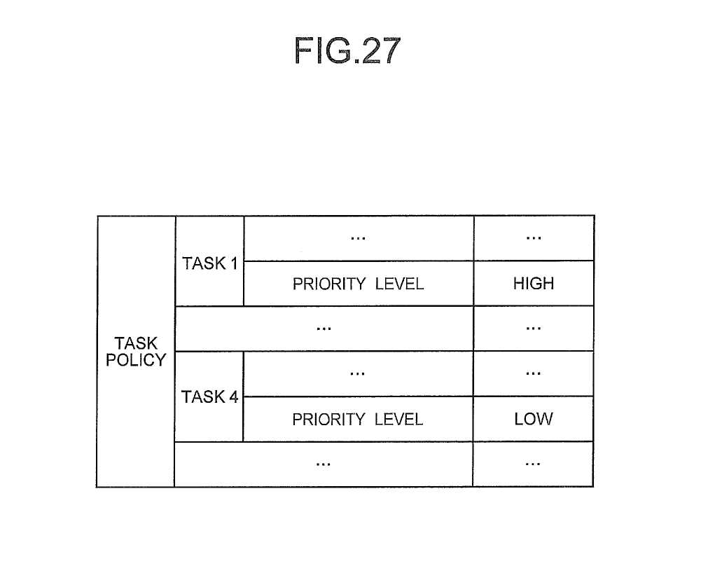

Since the priority level cannot be applied to a service, the client specifies the priority levels to the tasks after execution transition information is created by the control unit in response to a service execution request made by the client. Alternatively, a priority level(s) is registered in advance for a specific processing element(s). In the case of this embodiment, JPEG encoding is requested as a service, and the maximum numbers of parallel processes of the processing element PE1 and the processing element PE4 have been registered as 2 and 4 respectively (the same conditions as the second embodiment). In this situation, it is assumed that the client specifies priority levels for the execution transition information created by the control unit as shown in FIG. 27. FIG. 27 shows an example of the task policy in which priority levels are specified according to the sixth embodiment.

The relationship between the priority level and the number of parallel processes at the time when a task is solely executed while no other task is executed at the same time is defined as follows.

(1) High priority level: the task is executed with the maximum number of parallel processes.
(2) Middle priority level: the task is executed with the upper limit number of parallel processes. If the upper limit is not specified, the task is executed with the maximum number of parallel processes.
(3) Low priority level: the task is executed with the lower limit number of parallel processes. If the lower limit is not specified, the task is executed with the number of parallel processes equal to 1.

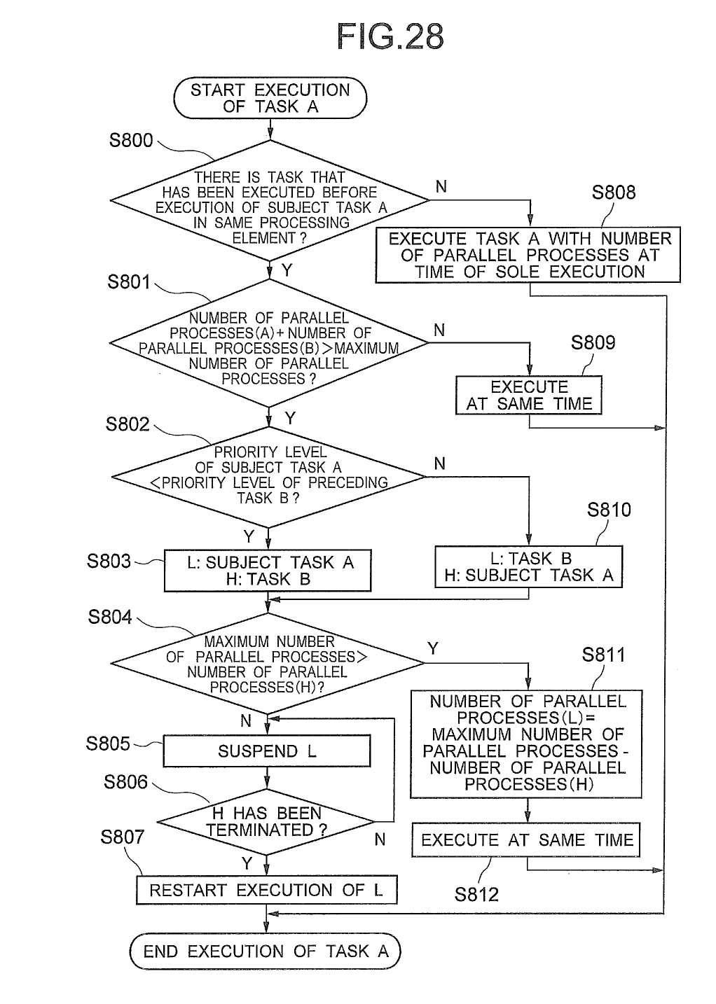

FIG. 28 is a flow chart of a process of adjusting the numbers of parallel processes among up to two tasks taking into account the priority levels of the two tasks at the time of executing the tasks according to the sixth embodiment.

FIG. 28 shows an example of the adjustment of the numbers of parallel processes at the time of execution in a case in which a certain processing element executes two or less tasks in parallel. The subject task (a task for which the adjustment is to be performed) is referred to as A, and the task that has already been executed on the processing element is referred to as B. Although adjustment of the number of parallel processes among three or more tasks are not described here, it is same as the adjustment of the number of parallel processes among two tasks in the respect that comparison and adjustment of the number of parallel processes at the time of execution are performed.

In step S800, a determination is made as to whether or not there is a task that has been executed before the execution of the subject task A in the same processing element. If no task has been executed in the same processing element (N in step S800), the process proceeds to step S808, where the task is executed with the aforementioned number of parallel processes at the time of sole execution. Then, the task execution is terminated.

On the other hand, if there is a task that has been executed before the execution of the subject task A in the same processing element (Y in step S800), the process proceeds to step S801. In step S801, a determination is made as to whether or not the sum of the number of parallel processes at the time of execution of task A and the number of parallel processes at the time of execution of task B exceeds the maximum number of parallel processes of the processing element. If the sum does not exceed the maximum number of parallel processes (N in step S801), the process proceeds to step S809. In step S809, the tasks A and B are executed at the same time. Then, the task execution is terminated.

On the other hand, if the sum exceeds the maximum number of parallel processes (Y in step S801), the process proceeds to step S802. In step S802, a determination is made as to whether or not the priority level of the subject task A is lower than the priority level of the task B that has already been executed. If the priority level of the subject task A is lower (Y in step S802), the process proceeds to step S803. In step S803, the task A is qualified as L, and the task B is qualified as H.

If the priority level of the subject task A is equal to or higher than the priority level of the task B (N in step S802), the process proceeds to step S810. In step S810, the task B is qualified as L, and the task A is qualified as H.

Both steps 803 and 810 proceed to step S804 after the processing. In step S804, a determination is made as to whether or not the maximum number of parallel processes of the processing element qualified as L is larger than the number of parallel processes of the task qualified as H at the time of execution.

If the maximum number of parallel processes of the processing element is larger than the number of parallel processes at the time of execution of the task qualified as H (Y in step S804), the number of parallel processes at the time of execution of the task qualified as L is replaced by the difference between the maximum number of parallel processes of the processing element and the number of parallel processes at the time of execution of the task qualified as H, in step S811. Then, in step S812, the tasks A and B are executed at the same time. Thereafter, the task execution is terminated.

If the determination in step S804 is negative, the process proceeds to step S805. In step S805, the task qualified as L is suspended. In step 806, a determination is made as to whether or not the task qualified as H has been terminated.

If the task qualified as H has not been terminated (N in step S806), the process returns to step S805, where the suspension of the task qualified as L is continued. If the task qualified as H has been terminated (Y in step S806), the execution of the task qualified as L is restarted with the number of parallel processes equal to that at the time of sole execution of the task. Then, the task execution is terminated.

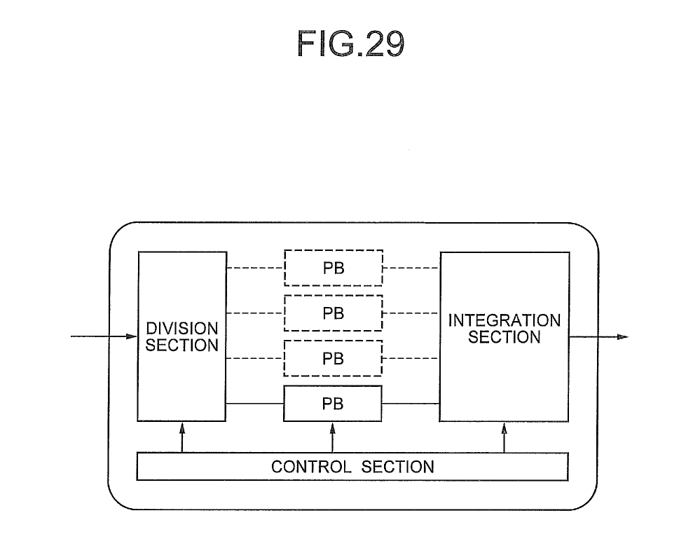

The task having a task ID of TK-104 is assigned to the processing element PE4 (VPE) with a priority level of “low”. Since the lower limit of the number of parallel processes is not specified, the task is executed with the number of parallel processes equal to 1 even if no other task is in execution (as illustrated by solid lines in FIG. 29). FIG. 29 is a diagram showing a status of processing element PE4 in which a task is executed with the number of parallel processes equal to 1 in the sixth embodiment.

### Seventh Embodiment

A seventh embodiment relates to a case of copying a processing block by itself, including a case in which the processing block is a general-purpose processing block. In the case described as the seventh embodiment, processing blocks that have different functions are not present in a processing element at the same time. Furthermore, the description will be made taking an example case in which a processing block is not loaded from outside, regardless of whether the processing block is a special-purpose processing block or a general-purpose processing block, and only program information and library information including reconfiguration information can be loaded from outside.

In the first to the sixth embodiments, all the processing blocks are special-purpose processing blocks that provide functions specialized for applications regardless of whether they are implemented as software or hardware. However, a general-purpose processing block that can provide a function same as a normal processing block specialized for an application by loading a library may be implemented in a processing element. This general-purpose processing block will be referred to as a GP-PB. In the following description, the expression like “loading a library” means loading program information of a library.

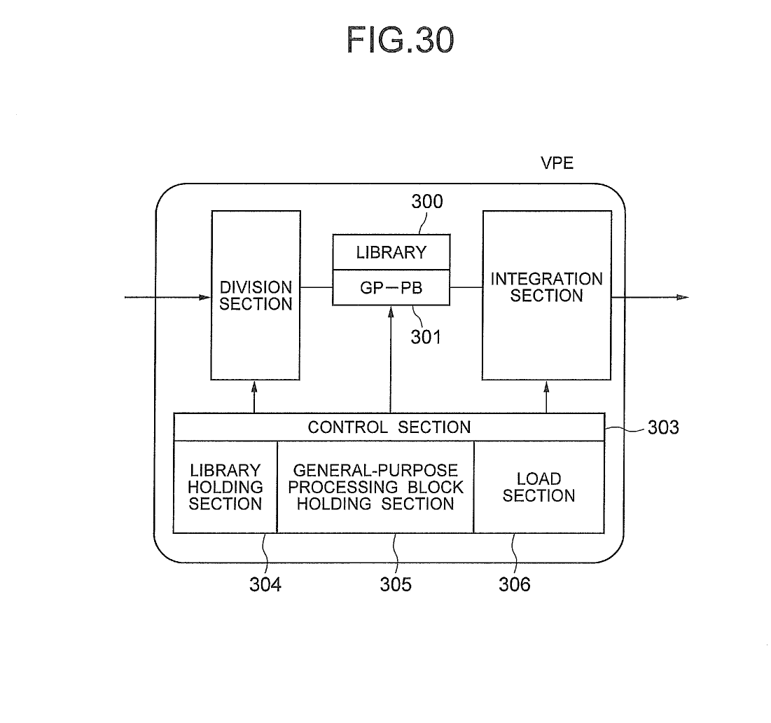

FIG. 30 is a diagram showing an exemplary configuration of the processing element according to the seventh embodiment in which the processing block is a general-purpose processing block. As illustrated in FIG. 30, if a library 300 that provides the function same as the function provided by a special-purpose processing block is downloaded to the GP-PB 301, the GP-PB 301 can be used as an equivalent of the special-purpose processing block. The control section 303 includes a library holding section 304, a general-purpose processing block holding section 305, and a load section 306. The load section 306 loads a library containing software information and reconfiguration information from outside to the general-purpose processing block. The library holding section 304 unloads or copies a library from the general-purpose processing block and holds the unloaded/copied library or a library loaded from the load section. The library holding section 304 also performs copying of the library it holds, loading of the library it holds to the general-purpose processing block, and deletion of an unnecessary library in the general-purpose processing block. The general-purpose processing block holding section 305 unloads or copies a processing block implemented as software and holds the processing block. The general-purpose processing block holding section 305 also performs copying of the general-purpose processing block that it holds, loading for allowing program information to be loaded to the general-purpose processing block, and deletion of an unnecessary general-purpose processing block. The GP-PB can be implemented as either software or hardware. However, in the following description, it is assumed that the GP-PB is implemented as software.

In the following, examples of the following three cases will be described:

(1) a case in which a GP-PB and a library are copied in combination;
(2) a case in which a GP-PB and a library are copied separately; and
(3) a case in which only a library is copied.

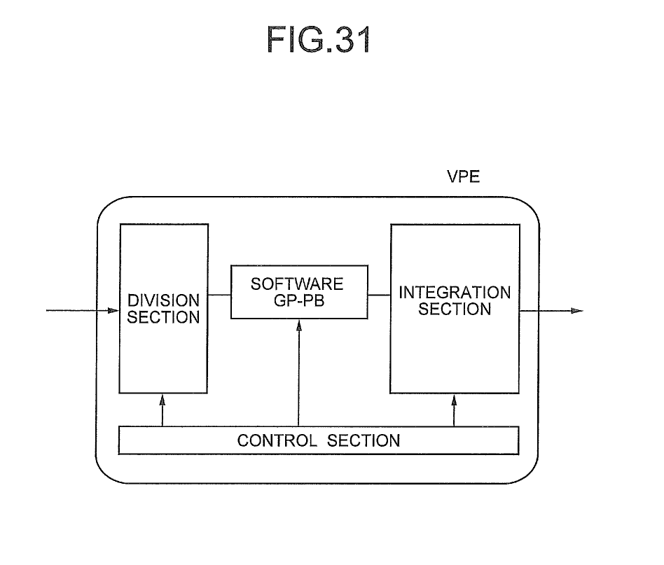

(1) A case in which a GP-PB and a library are copied in combination (FIGS. 31 to 35)

In this case, in the initial state, there is no processing element that has a special-purpose processing block for executing JPEG encoding as a service. Therefore, a library is dynamically downloaded to a processing element (VPE) having a GB-PB. The initial state of the processing element having the GB-PB is shown in FIG. 31. FIG. 31 is a diagram showing the initial state of the processing element (VPE) according to the seventh embodiment.

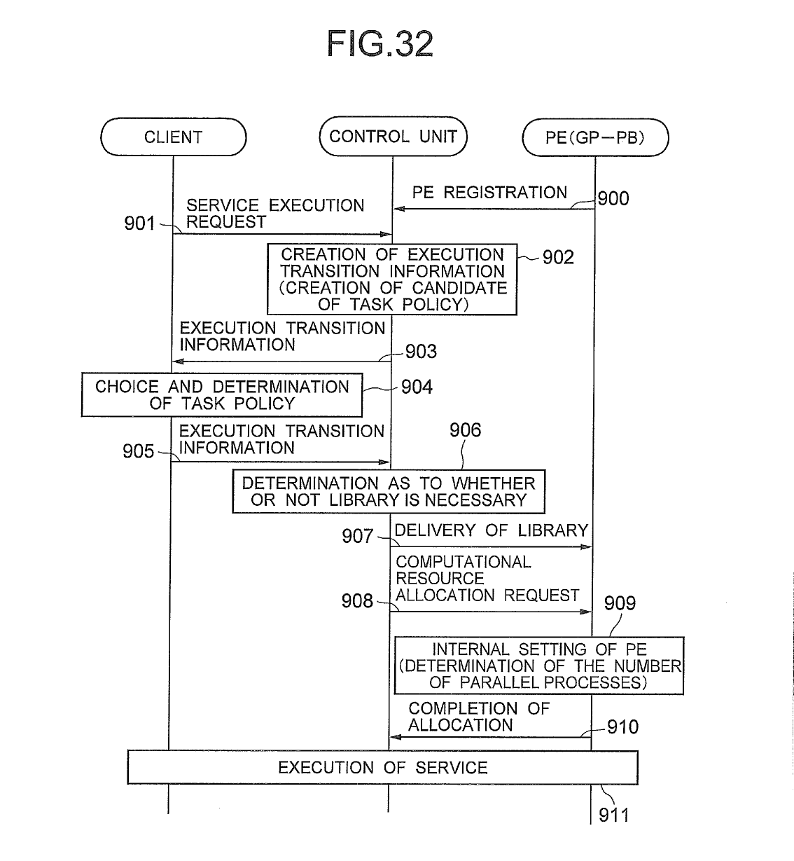

FIG. 32 is a chart showing an execution sequence according to the seventh embodiment.

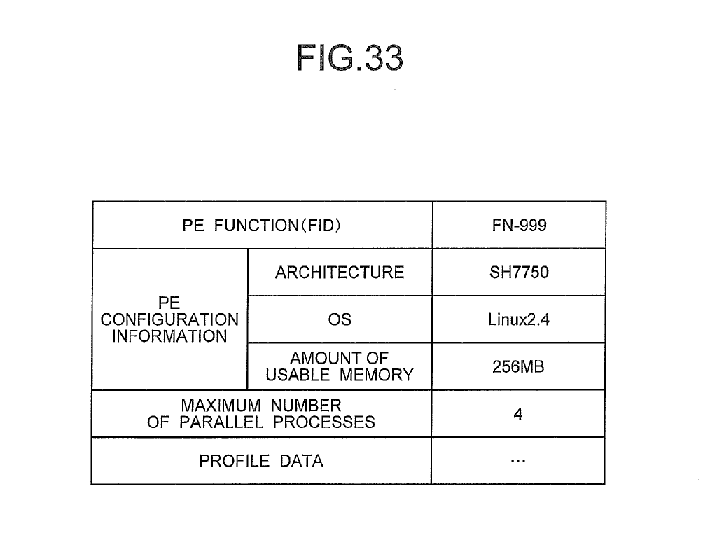

In step 900 of the sequence, the processing element having GP-PB is registered in the control unit with a function ID (FID) of FN-999. An example of the PE registration information is shown in FIG. 33. In this case, the maximum number of parallel processes is 4. FIG. 33 is a table showing an example of the PE registration information of the processing element having the general-purpose processing block according to the seventh embodiment.

In step 901 of the sequence, the client makes a request for execution of the JPEG decoding, as a service execution request, to the control unit with designation of a service ID of SV-823.

In step 902 of the sequence, the control unit creates execution transition information containing a candidate task policy based on the PE registration information. The task of TK-104 can be assigned to the processing element having GP-PB. In other words, the processing element having GP-PB can provide the function same as a special-purpose processing block having the function of TK-104 by downloading a library to the GP-PB, and designates the processing element having GP-PB in the execution transition information. The execution transition information created here is assumed to be the same as that shown in FIG. 4, and the candidate task policy same as that shown in FIG. 14 is created. If the processing path information for constituting the service to be executed and the task policy are the same, the execution transition information is the same, even in the case where the processing element having the general-purpose processing block is used.

In step 903 of the sequence, the control unit sends the execution transition information containing the candidate task policy to the client.

In step 904 of the sequence, the client only makes a choice on the number of parallel processes. Here, the client specifies the number of parallel processes of 2 for the task 4, which corresponds to a task having a task ID of TK-104, as with the case shown in FIG. 15.

In step 905 of the sequence, the client sends the execution transition information containing the chosen task policy to the control unit.

In step 906 of the sequence, the control unit firstly checks the execution transition information containing the task policy. The control unit knows the function of the library loaded to the processing element having GP-PB and the operation state of the library. The control unit determines whether or not the library is necessary based on the execution transition information containing the task policy.

In the seventh embodiment, since the library providing the function of FN-104 necessary for the execution of the task of TK-104 has not been downloaded to the processing element having GP-PB, the control unit determines that it is necessary to dynamically deliver the library providing the function of FN-104.

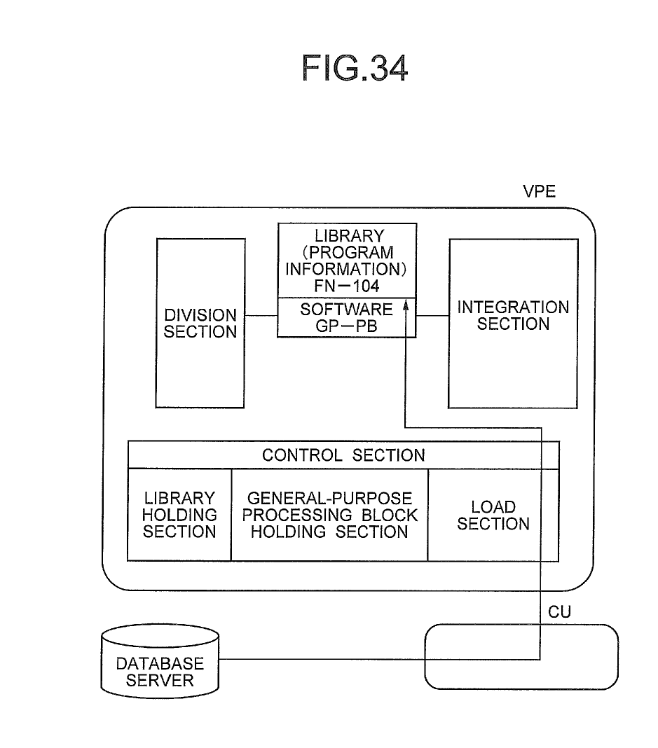

In step 907 of the sequence, the control unit obtains the program information as the library providing the function of FN-104 to the GP-PB from, for example, a database server and downloads the library through the load section of the processing element (FIG. 34). FIG. 34 is a diagram showing the state in which the library has been loaded to the GP-PB according to the seventh embodiment.

In step 908 of the sequence, the processing element receives a computational resource allocation request from the control unit. In step 909 of the sequence, the processing element recognizes the task to be executed and determines the number of parallel processes at the time of execution.

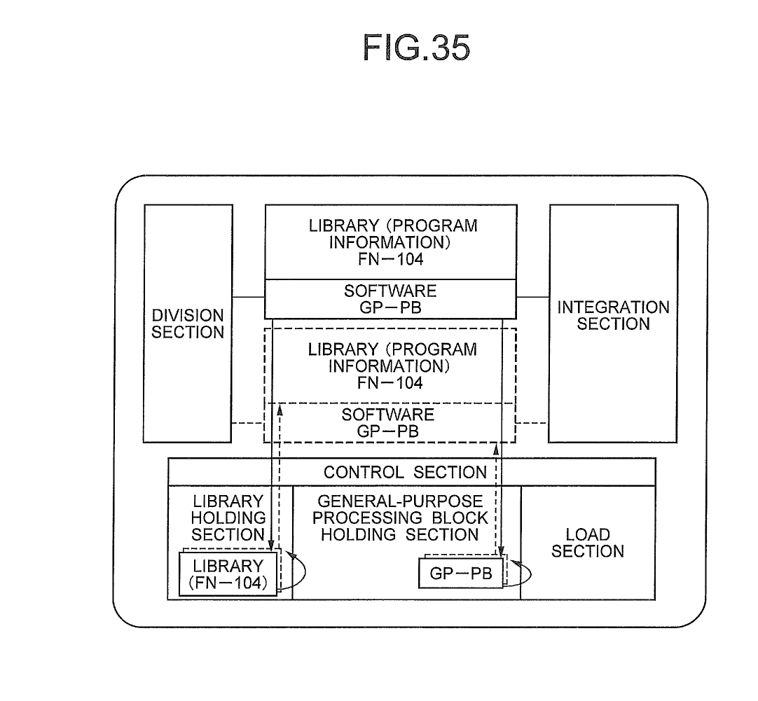

At this stage, having only one processing block despite the number of parallel processes equal to 2, the processing element copies the GP-PB and the library in combination to reconfigure the internal configuration so that the parallel processes can be performed with the number of parallel processes equal to 2 (FIG. 35). FIG. 35 is a diagram showing the state in which the GP-PB and the library are copied in combination according to the seventh embodiment. More specifically, the main control section copies the GP-PB to the general-purpose processing block holding section while maintaining the original GP-PB and, similarly, copies the library to the library holding section while maintaining the original library. The corresponding holding sections copy the GP-PB and the library respectively. The copied GP-PB and library are reloaded so as to be connected with the division section and the integration section.

In step 910 of the sequence, when the processing element becomes ready for execution of the task, it may be concluded that the allocation of computational resources has been completed, and the processing element returns a notification of the completion of computational resource allocation to the control unit.

In step 911 of the sequence, the processing of the service is continued.

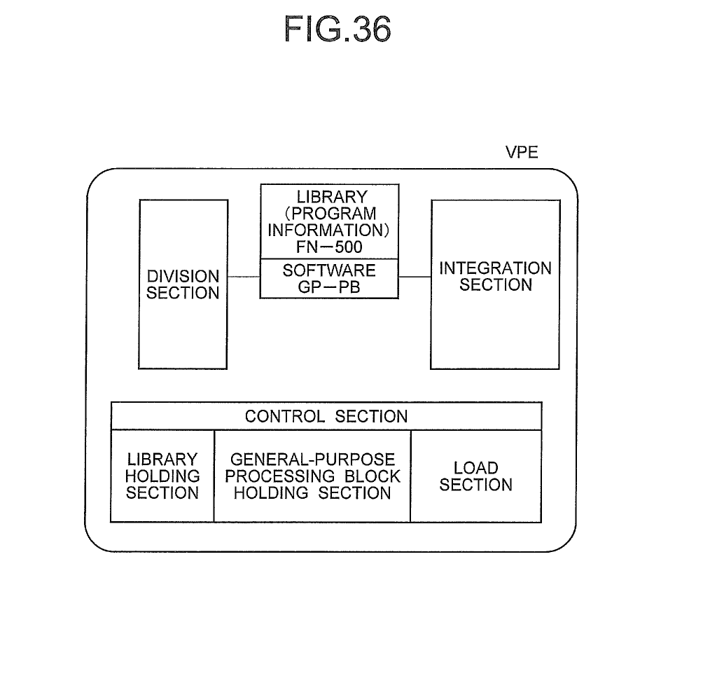

(2) A case in which a GP-PB and a library are copied separately (FIGS. 36 to 38)

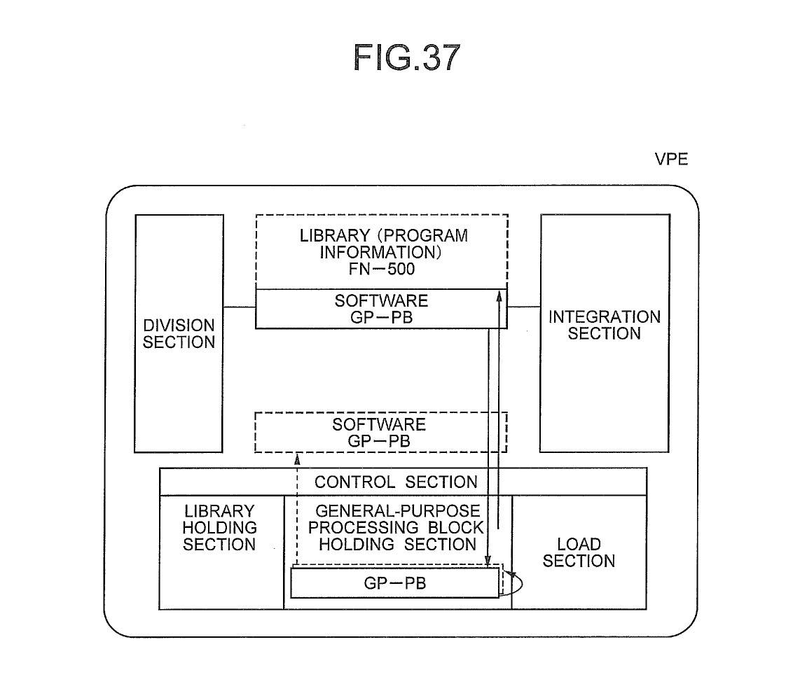

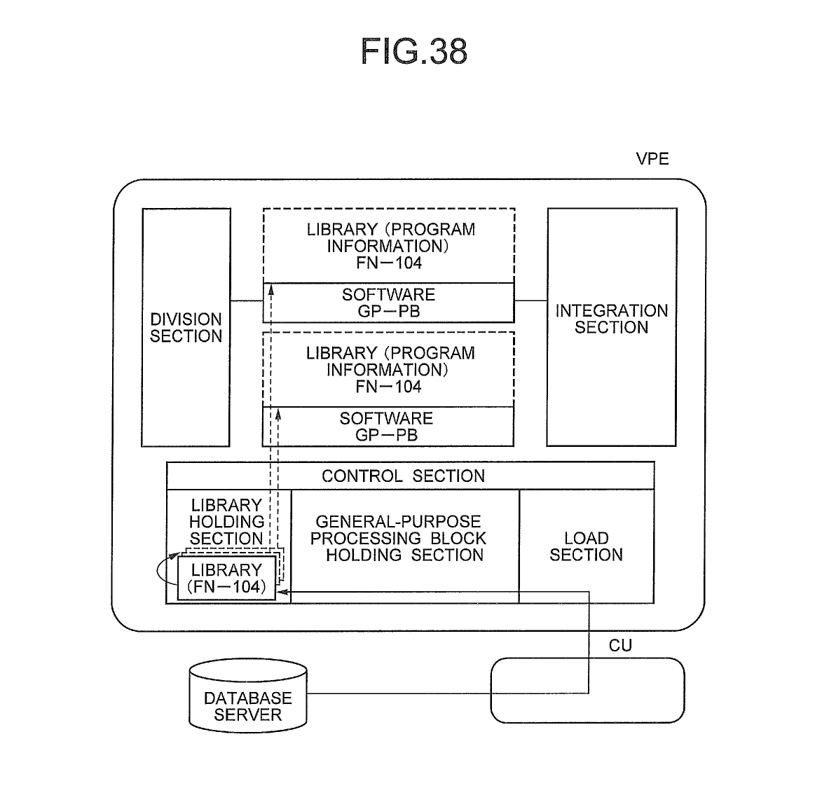

FIGS. 36 to 38 are a series of diagrams showing states of the processing element (VPE) in a process in which the GP-PB and the library are loaded and copied separately in the processing element (VPE) according to the seventh embodiment. FIG. 36 is a Diagram Showing the State Before Copying, FIG. 37 is a diagram showing the state in which the GP-PB is copied, and FIG. 38 is a diagram showing the state in which the library is copied and loaded.

In this case, in the initial state, a library that provides the function of FN-500 has already been loaded to the GP-PB (FIG. 36). If it is required that the GP-PB executes the task of TK-104 with the number of parallel processes equal to 2, the processing element deletes the library that provides the function of FN-500, then copies the GP-PB in the general-purpose processing block holding section, and then loads the copied GP-PB, thereby achieving a state that allows loading of a library to it (FIG. 37). After that, the processing element loads the library providing the function of FN-104, which has been obtained from the database server by the control unit, by the load section and copies it. Then the library holding section loads the library to the two GP-PBs (FIG. 38). Thus, the parallel processing can be executed. The GP-PB may be copied in advance while the GP-PB is providing the function of FN-500.

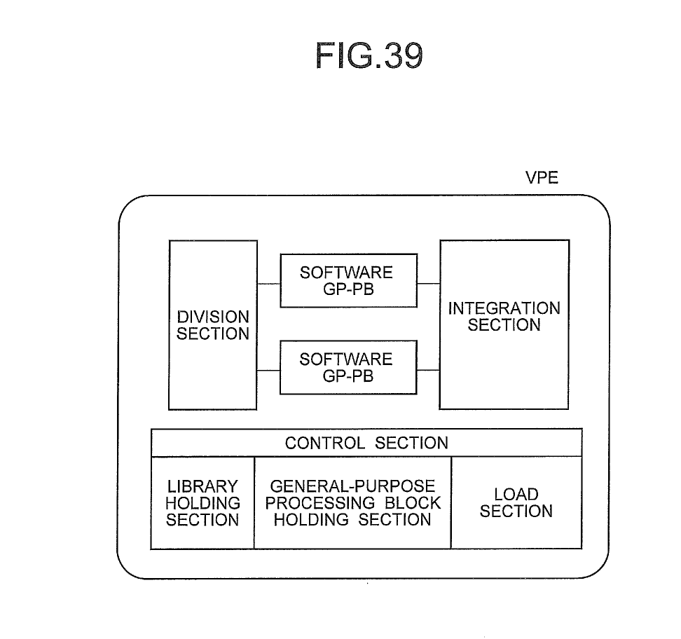

(3) A case in which only a library is copied (FIGS. 39 to 42)

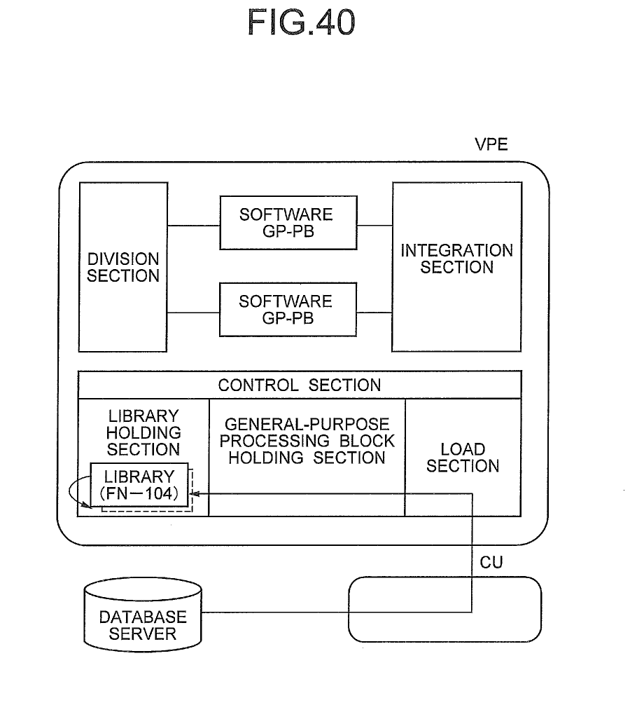

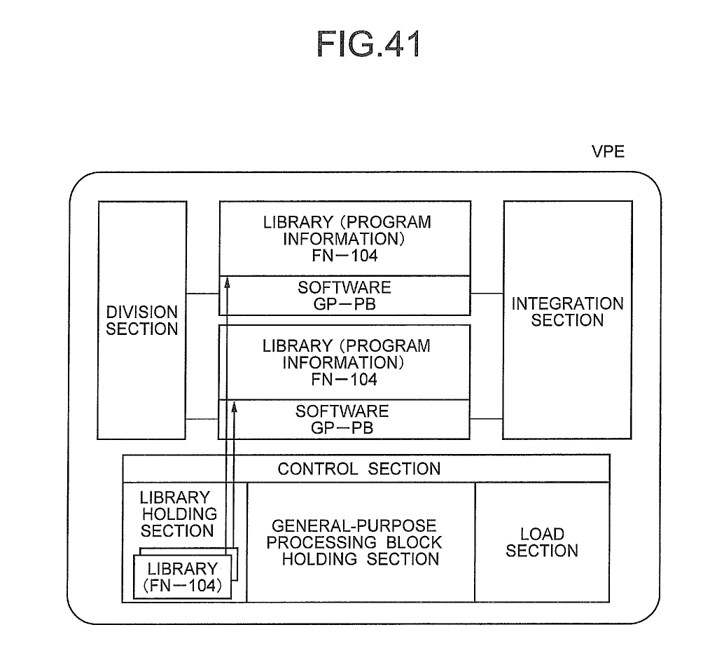

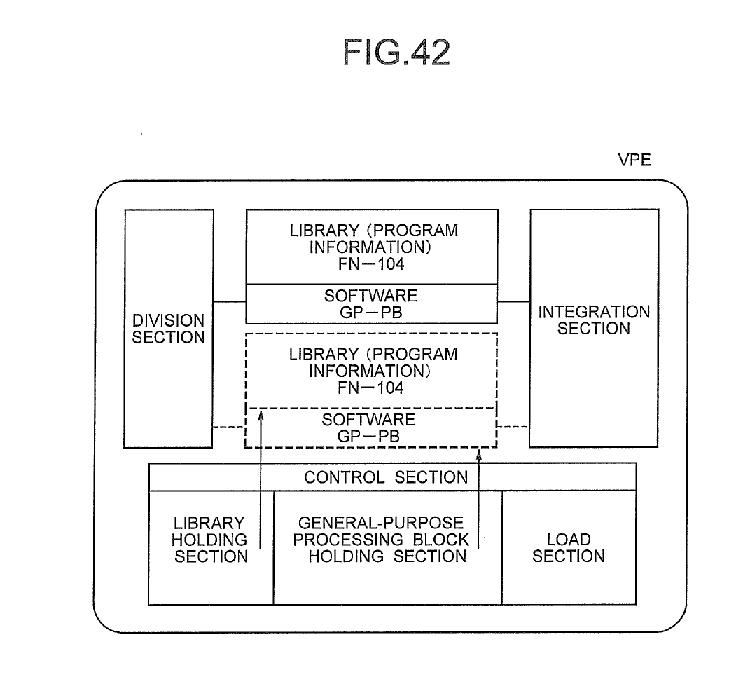

FIGS. 39 to 42 are a series of diagrams showing states of the processing element (VPE) in a process in which only the library is loaded and copied in the processing element (VPE) according to the seventh embodiment. FIG. 39 is a diagram showing the state before the library is copied. FIG. 40 is a diagram showing the state in which the library delivered from the control unit is held and copied. FIG. 41 is a diagram showing the state in which the copied library is loaded to GP-PBs. FIG. 42 is a diagram showing the state in which the library and the processing block are deleted.

In this case, the task of TK-104 is to be executed on the processing element (VPE) having the GP-PB with the number of parallel processes equal to 2. If the processing element has two GP-PBs already (FIG. 39), the processing element holds the library delivered from the control unit in step S907 in FIG. 32 in the library holding section and copies the library held in the library holding section (FIG. 40), and then loads the library (FN-104) to each of the GP-PBs (FIG. 41). For example, if the priority level of this task is low, and the library and the GP-PB should be deleted in order to reduce the number of parallel processes to 1, the library holding section and the general-purpose processing block holding section delete the library and the GP-PB respectively (FIG. 42).

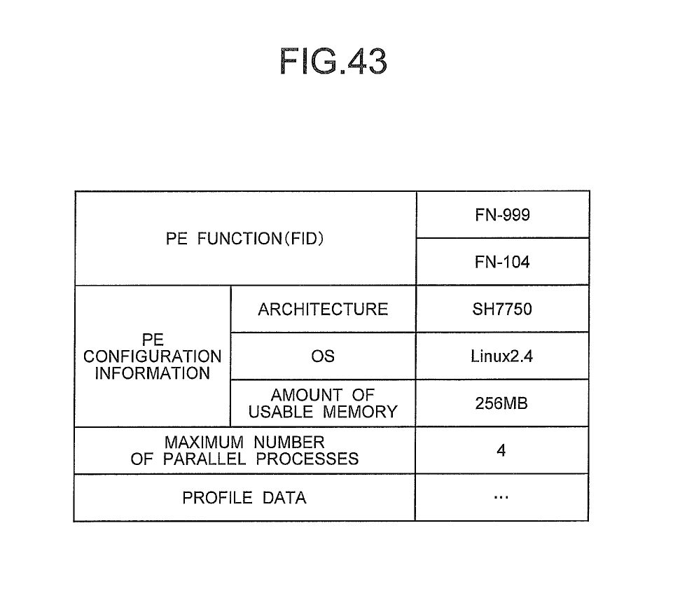

If the processing element already has the library and the GP-PB in combination as shown in FIG. 41, the two function IDs of the GP-PB and the library are registered to the control unit (FIG. 43). FIG. 43 is a table showing an example of the PE registration information of the processing element having the GP-PB and the library according to the seventh embodiment.

All the GP-PBs can be copied if needed as described in cases (1) and (2). In addition, as described in case (1), a GP-PB and a library can be copied in combination, and a GP-PB and a library can be copied separately (as described in cases (2) and (3)). It is also possible to delete a library and newly loads another library having another function from outside. In any case, the number of parallel processes can be dynamically controlled as desired by copying or deleting the processing block.

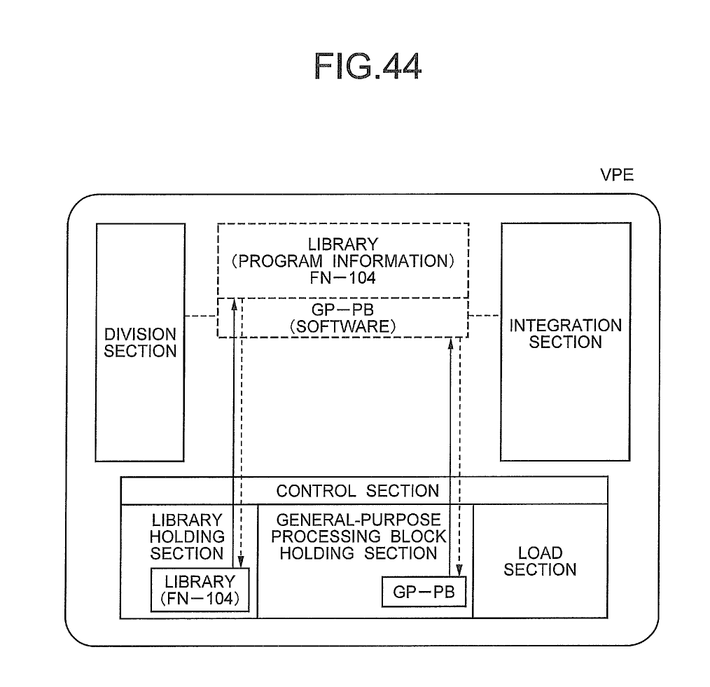

The GP-PB and the library can be unloaded to the holding sections. All the GP-PBs and the libraries can be unloaded without causing any problem. The control section can hold one of the GP-PB or the library, or the GP-PB and library in combination in the holding sections (FIG. 44). One or more GP-PBs or libraries held in the holding sections can be reloaded at arbitrary timing. Although a plurality of libraries can be loaded from outside and held, the processing element can provide only one function at a time. FIG. 44 is a diagram showing the state in which the GP-PB has been unloaded and completely deleted or reloaded according to the seventh embodiment. FIG. 44 also shows the configuration of the holding sections.

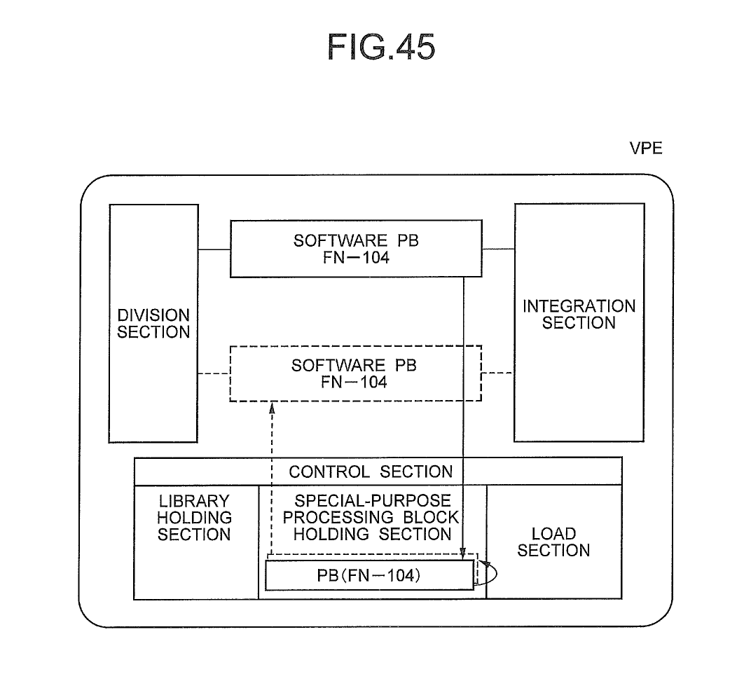

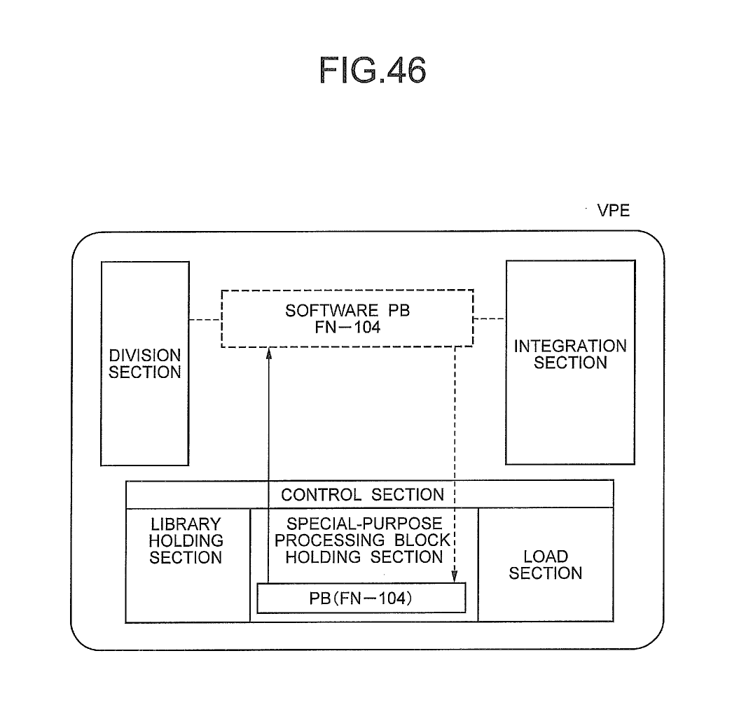

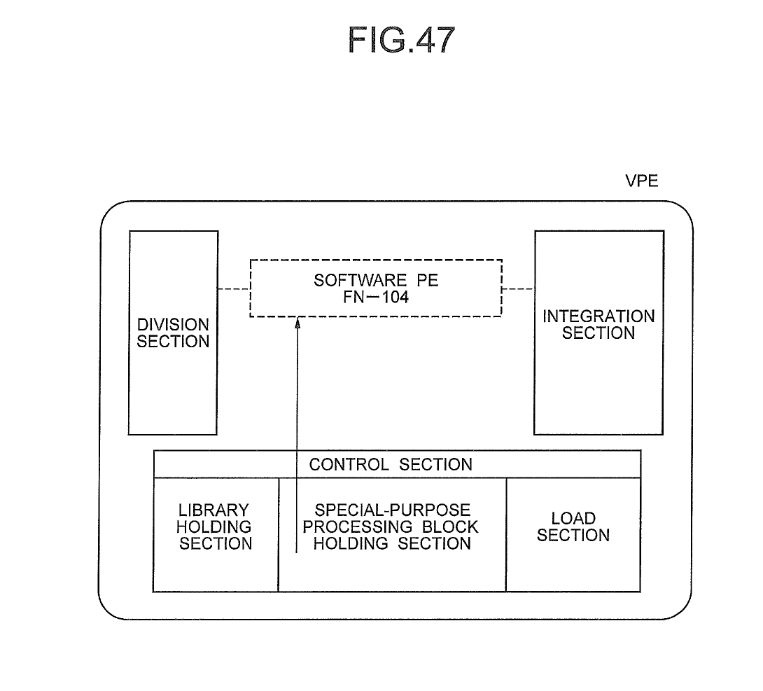

In the seventh embodiment, the processing block that provides a specific function using a GP-PB and a library in combination has been described. Since the combination of the GP-PB and the library is functionally equivalent to a special-purpose processing block PB, the above-described embodiment can also be applied to a special-purpose processing block implemented as software. More specifically, a special-purpose processing block providing a certain function can be copied, unloaded, or deleted (FIGS. 45 to 47). In addition, the entire special-purpose processing block can be held in the holding section. FIGS. 45 to 47 are a series of diagrams showing the copying and unloading of a special-purpose processing block. FIG. 45 is a diagram showing the state in which the special-purpose processing block holding section copies the processing block and loads it as another processing block to enable processing. FIG. 46 is a diagram showing the state in which the special-purpose processing block holding section unloads all the processing blocks and holds them, or unloads all the processing blocks and reloads them to enable processing. FIG. 47 is a diagram showing the state in which the special-purpose processing block holding section deletes all the processing blocks.

### Eighth Embodiment

An eighth embodiment relates to implementation of a processing element as hardware.

In the first to seventh embodiments, the processing element is implemented as software, and the processing blocks can be increased/decreased as desired up to the maximum number of parallel processes. Although the maximum number of parallel processes depends on the memory capacity, it may be regarded to be unlimited, unless blocks have significantly large sizes relative to the memory capacity.

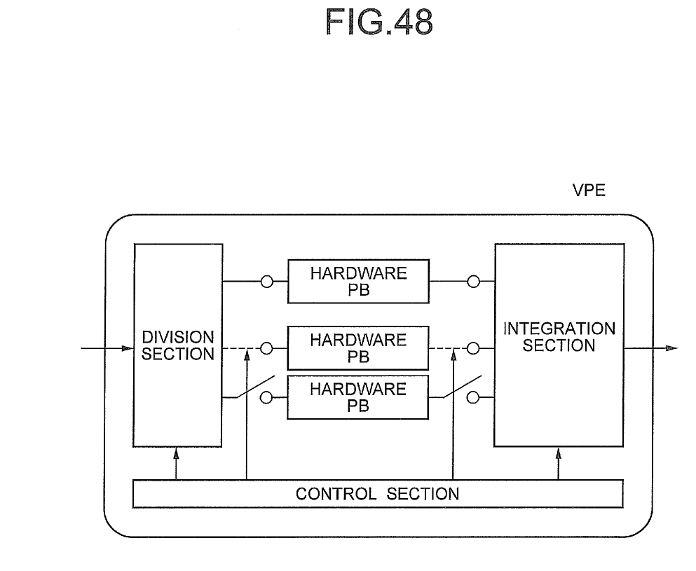

On the other hand, the processing element may be implemented as hardware. In the case of the processing element implemented as hardware, since the processing blocks to be used are circuits that have been built in advance, the maximum number of parallel processes is limited by the number of the already built processing blocks. The processing block may be continuously connected with the division section or the integration section. However, the processing paths may be dynamically configured by providing switches to the processing blocks as shown in FIG. 48. FIG. 48 is a diagram showing an example of dynamic switching to the processing blocks implemented as hardware according to the eighth embodiment.

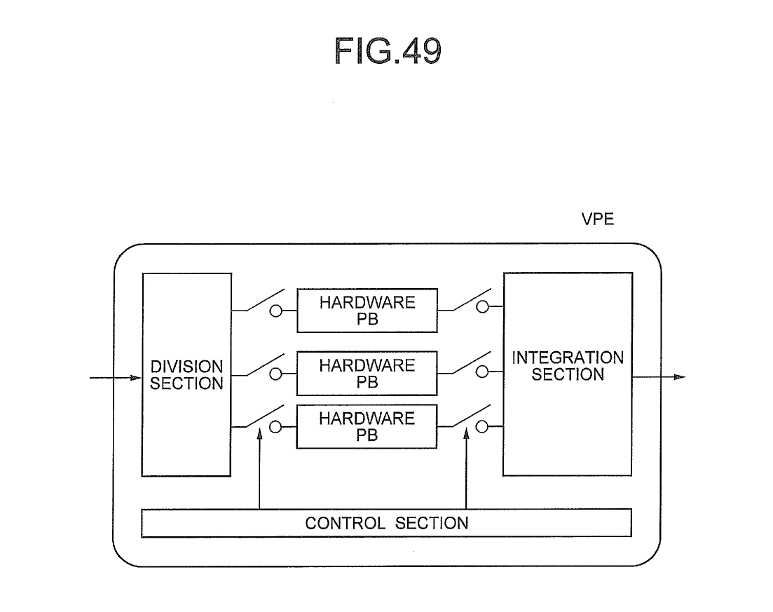

As shown in FIG. 49, the number of processing blocks can be dynamically increased/decreased in the range from zero to the maximum number of parallel processes, when they are not in use. It is possible to decrease the power consumption by opening all the switches. FIG. 49 is a diagram showing the state in which all the switches are opened in the processing element according to the eighth embodiment.

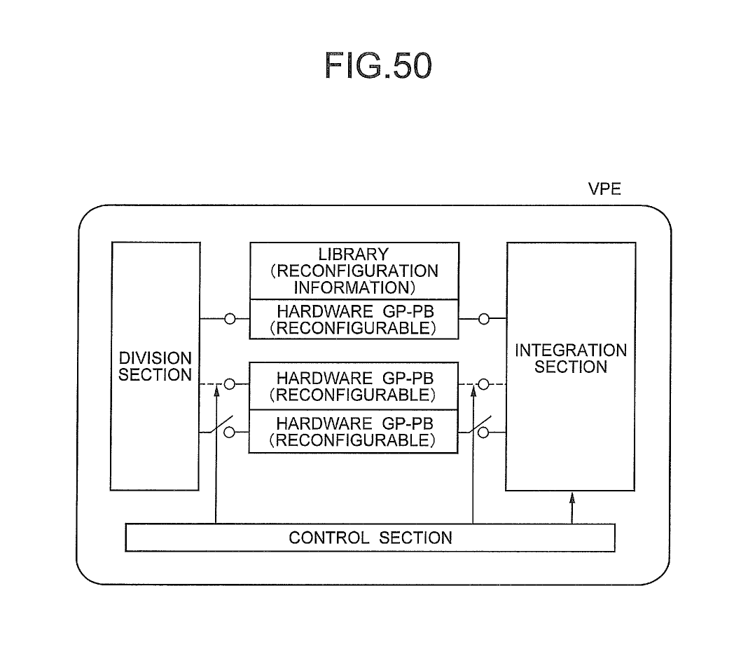

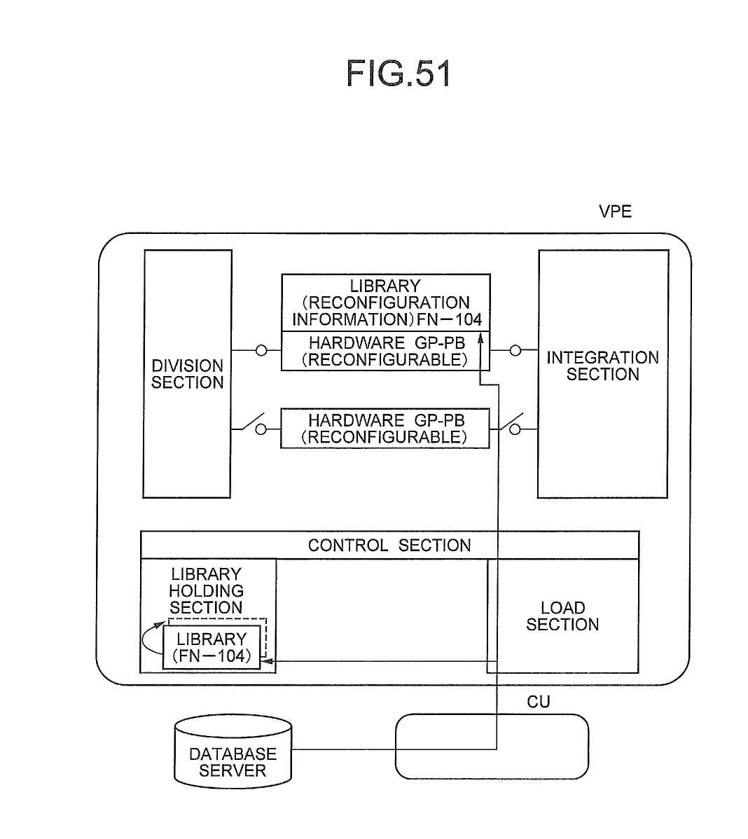

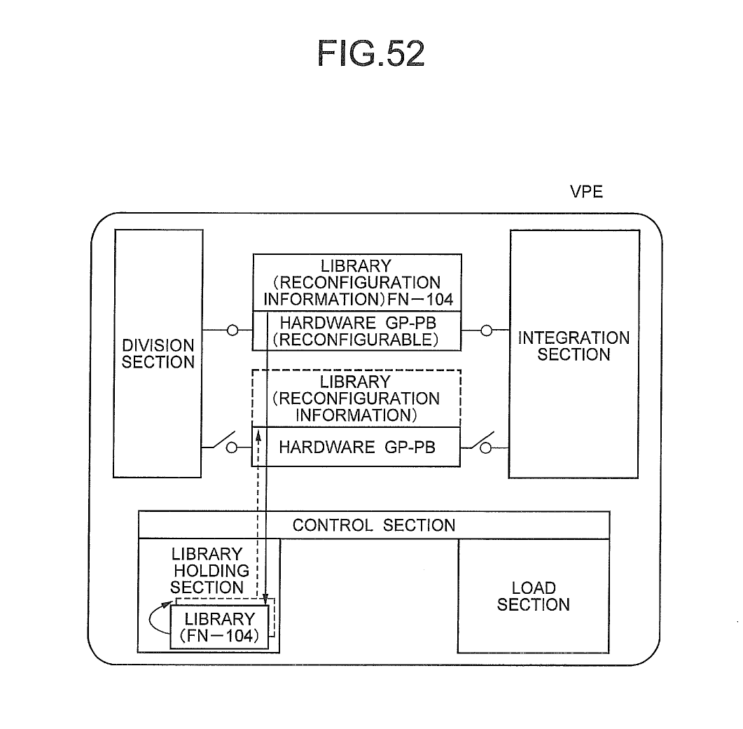

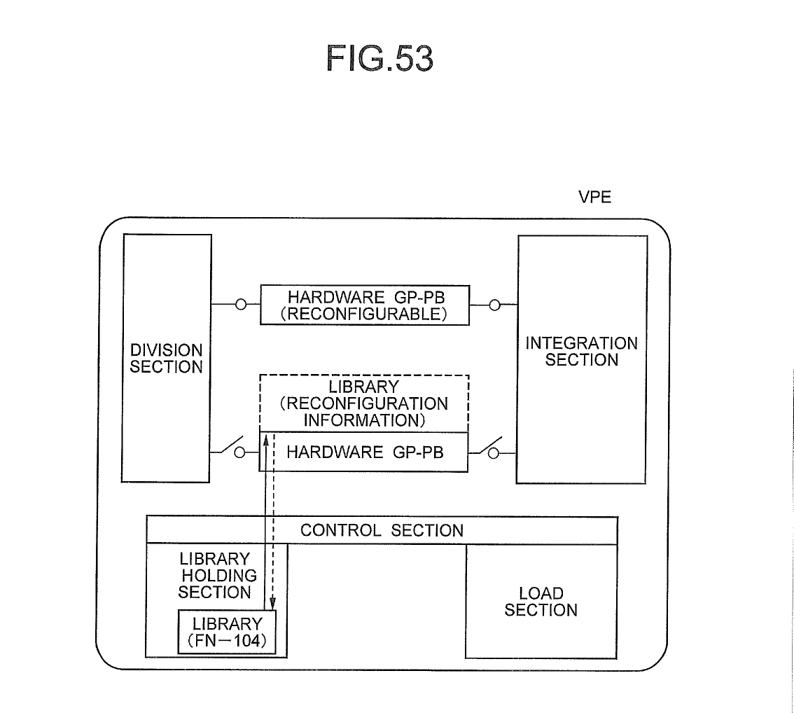

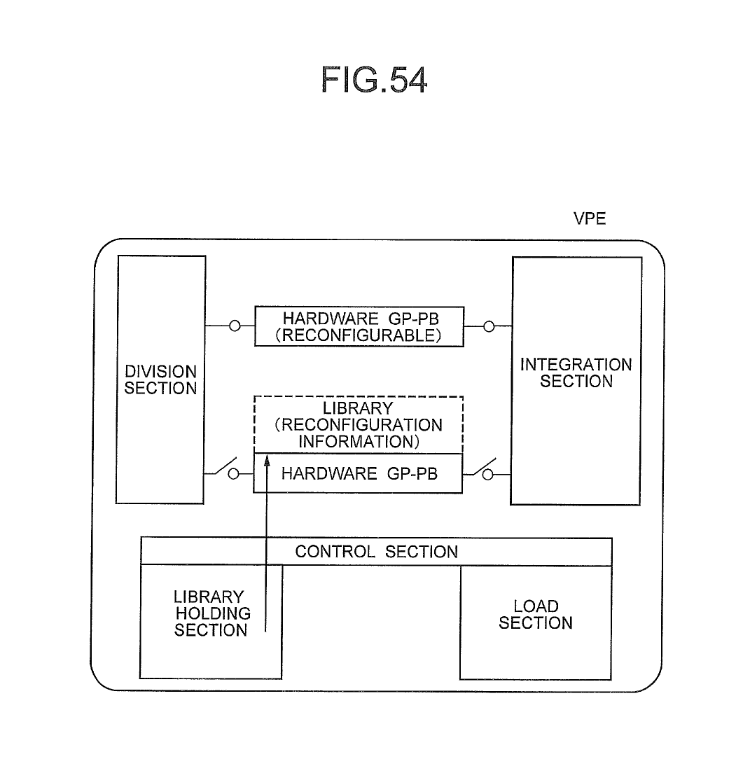

Furthermore, as shown in FIGS. 50 to 54, when a dynamic reconfigurable processor (DRP) is used as a processing block, the processing block can be regarded as a general-purpose processing block (GP-PB) implemented as hardware. Since the processing block is a block implemented as hardware, the input and output of the processing block are connected/disconnected by dynamic switching. The DRP cannot be copied. The reconfiguration information is copied as a library and loaded or unloaded to the DRP. The same reconfiguration information is loaded to all the DRPs. The reconfiguration information to be held in the library holding section can be loaded as a library from outside. The library holding section may hold a plurality of sets of reconfiguration information. There can be provided a processing block whose internal configuration can be reconfigured by dynamically loading a library. In this case, the library includes reconfiguration information for the dynamic reconfigurable processor such as information on interconnection or information on switching. FIGS. 50 to 54 are a series of diagrams showing an example of a processing element having a dynamic reconfigurable processor as a processing block according to the eighth embodiment. FIG. 50 is a diagram showing an example of dynamic switching to the dynamic reconfigurable processing block. FIG. 51 is a diagram showing the state in which the control unit loads reconfiguration information obtained from a database server to the dynamic reconfigurable processing block through the load section, or the state in which the control unit loads the reconfiguration information to the library holding section and copies it. FIG. 52 is a diagram showing the state in which the library holding section copies the reconfiguration information and is loading the copied reconfiguration information to the processing block. FIG. 53 is a diagram showing the state in which the library is unloaded and then reloaded. FIG. 54 is a diagram showing the state in which the library holding section deletes the reconfiguration information. In any case, the dynamic reconfigurable processing block can provide the function same as a general-purpose processing block implemented as software.

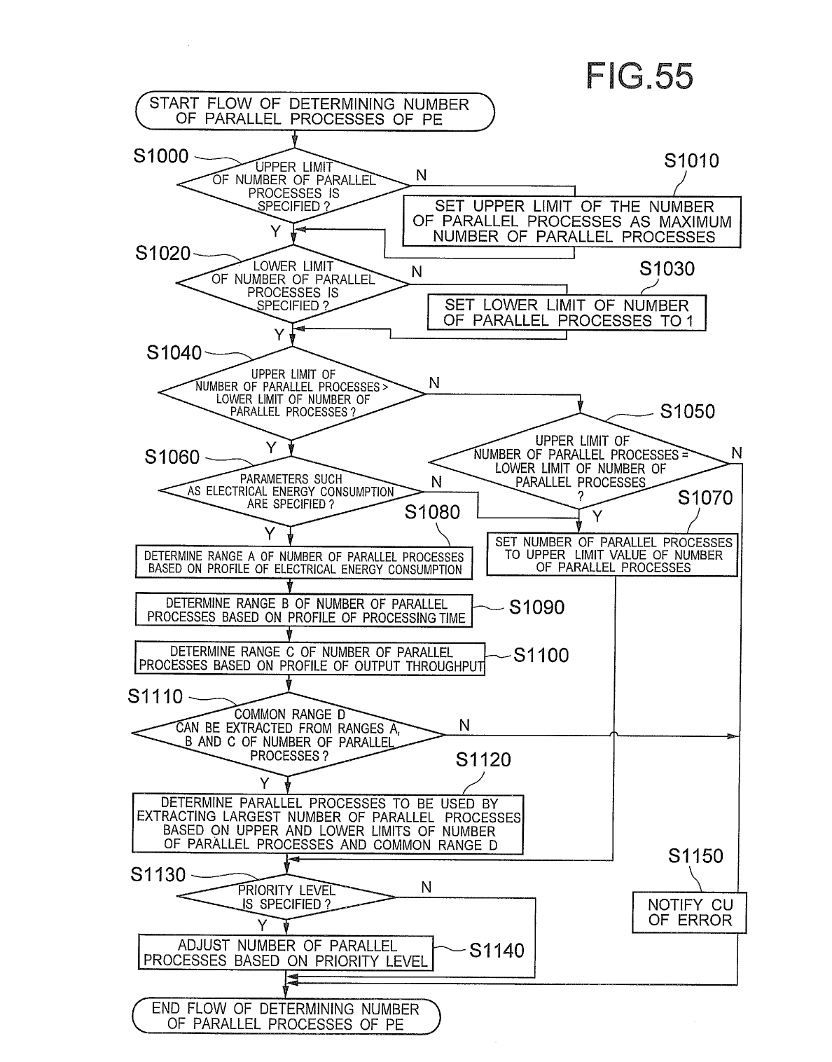

In the following, a process of determining the number of parallel processes in the processing element will be described with reference to FIG. 55. FIG. 55 is a flow chart of a process of determining the number of parallel processes in the processing element. After receiving parameters of the task policy, the processing element determines the number of parallel processes in accordance with the process shown in FIG. 55. The process of determining the number of parallel processes described here can be applied to the first, second and fourth to eighth embodiments.

In step S1000, it is checked whether or not the upper limit of the number of parallel processes is set (or specified) in the task policy_. If the upper limit is set (Y in step S1000), the process proceeds to step S1020. If the upper limit is not set (N in step S1000), the process proceeds to step S1010. In step S1010, the upper limit of the number of parallel processes is set to the maximum number of parallel processes. Then, the process proceeds to step S1020.

In step S1020, it is checked whether or not the lower limit of the number of parallel processes is set (or specified) in the task policy. If the lower limit is set (Y in step S1020), the process proceeds to step S1040. If the lower limit is not set (N in step S1020), the process proceeds to step S1030. In step S1030, the lower limit of the number of parallel processes is set to 1. Then, the process proceeds to step S1040.

In step S1040, it is determined whether or not the upper limit of the number of parallel processes is larger than the lower limit of the number of parallel processes. If the upper limit of the number of parallel processes is larger than the lower limit of the number of parallel processes (Y in step S1040), the process proceeds to step S1060. If the upper limit of the number of parallel processes is equal to or smaller than the lower limit of the number of parallel processes (N in step S1040), the process proceeds to step S1050.

In step S1050, it is determined whether or not the upper limit of the number of parallel processes is equal to the lower limit of the number of parallel processes. If the upper limit of the number of parallel processes is equal to the lower limit of the number of parallel processes (Y in step S1050), the process proceeds to step S1070, because there is no option in the number of parallel processes. If the upper limit of the number of parallel processes is not equal to the lower limit of the number of parallel processes (N in step S1050), the process proceeds to step S1150, where an error notification is sent to the control unit.

In step S1060, it is checked whether or not parameters of the task policy other than the number of parallel processes and the priority level such as the electrical energy consumption, the processing time, and the output throughput are set. If any one of the parameters is set (Y in step S1060), the process proceeds to step S1080. If none of the parameters is set (N in step S1060), the process proceeds to step S1070.

In step S1070, the number of parallel processes is set to the upper limit value of the number of parallel processes, and the process proceeds to step S1130.

In step S1080, the upper and lower limits of the number of parallel processes are calculated based on the profile of the electrical energy consumption to determine a range A of the number of parallel processes, and then process proceeds to step S1090.

In step S1090, as with step S1080, the upper and lower limits of the number of parallel processes are calculated based on the profile of the processing time to determine a range B of the number of parallel processes, and then process proceeds to step S1100.

In step S1100, as with steps S1080 and S1090, the upper and lower limits of the number of parallel processes are calculated based on the profile of the output throughput to determine a range C of the number of parallel processes, and then process proceeds to step S1110.

In step S1110, it is determined whether or not a common range D can be extracted from the ranges A, B and C of the number of parallel processes. If the common range D can be extracted (Y in step S1110), the process proceeds to step S1120. If the common range D cannot be extracted (N in step S1110), the process proceeds to step S1150. For example, If the range A of the number of parallel processes includes 1, 2, and 3, the range B includes 2 and 3, and the range C includes 2, 3, and 4, the common range D includes 2 and 3.

In step S1120, a common range is further extracted from the range between the upper and lower limits of the number of parallel processes and the common range D. The largest number in the extracted range is determined as the number of parallel processes to be used. Then, the process proceeds to step S1130. For example, if the common range D includes 2 and 3, the upper limit of the number of parallel processes is 4, and the lower limit of the number of parallel processes is 2, the number of parallel processes to be used is determined to be 3.

In step S1130, it is checked whether or not the priority level is specified. If the priority level is specified (Y in step S1130), the process proceeds to step S1140. If the priority level is not specified (N in step S1130), the process is terminated.

In step S1140, the number of parallel processes is adjusted based on the priority level in accordance with, for example, the process shown in FIG. 28. Then, the process is terminated.

In step S1150, since there is no allowable number of parallel processes, an error is returned to the control unit, and the process is terminated.

Though not shown in the drawings, in the case where the lower limit of output throughput and the upper limit of electrical energy consumption are specified in the task policy, and the type of quality assurance is the best effort type, if the output throughput and the electrical energy consumption cannot take values within the range limited by the task policy, the number of parallel processes is dynamically adjusted by the control section in such a way that optimum trade-off between the output throughput and the electrical energy consumption is achieved. In the case where the type of quality assurance is the guarantee type, the number of parallel processes is adjusted in such a way that the regulations on the values of these parameters placed by the task policy are ensured.

As described above, the distributed processing system according to the present invention can be advantageously applied to a distributed processing system in which the most suitable number of parallel processes is desired to be specified.

In a system defined by a data flow type module network including computation modules that provide one or more specific functions in order to implement a service required by a user, the present invention can provide an advantageous distributed processing system in which not only the number of parallel processes and the overall performance but also the electrical energy consumption and the processing time are used as indexes in performing virtual parallel processing in the modules, and the optimum number of parallel processes is determined based on these indexes.

Furthermore, according to the present invention, there can be provided a distributed processing system in which the number of processing blocks in a computation module can be dynamically increased/decreased based on the dynamically defined number of parallel processes.

Furthermore, according to the present invention, an application execution environment optimal for a user can be created by specifying, as a policy, an index that is considered to be important at the time of executing the application, without need for designation of the number of parallel processes by the user.

What is claimed is:

1. A distributed processing system for executing an application, comprising:
a processing element capable of performing parallel processing;
a control unit; and
a client that makes a request for execution of an application to the control unit;
wherein, the processing element comprises, at least at the time of executing the application:
one or more processing blocks that process respectively one or more tasks to be executed by the processing element;
a processing block control section for calculating the number of parallel processes based on an index for controlling the number of parallel processes received from the control unit;
a division section that is controlled by the processing block control section to divide data to be processed input to the processing blocks in accordance with the number of parallel processes; and
an integration section that is controlled by the processing block control section to integrate processed data output from the processing blocks in accordance with the number of parallel processes.

2. The distributed processing system according to claim 1, wherein the processing element has a plurality of the processing blocks prepared in advance.

3. The distributed processing system according to claim 1, wherein when connected to the control unit, the processing element registers its own function information, configuration information, the maximum number of parallel processes, and PE information including a profile expressing a characteristic between the number of parallel processes and the index for controlling the number of parallel processes.

4. The distributed processing system according to claim 1, wherein the client specifies criteria concerning the execution of the application.

5. The distributed processing system according to claim 4, wherein
the control unit determines and presents candidates of the index for controlling the number of parallel processes based on the PE information and/or the criteria concerning the execution of the application, and
the client determines the index for controlling the number of parallel processes by choosing the index from among the candidates of the index.

6. The distributed processing system according to claim 4, wherein the control unit determines the index for controlling the number of parallel processes based on the PE information and/or the criteria concerning the execution of the application.

7. The distributed processing system according to claim 1, wherein the index for controlling the number of parallel processes includes an upper limit and a lower limit of the number of parallel processes of the processing element.

8. The distributed processing system according to claim 7, wherein when the upper limit and the lower limit of the number of parallel processes are different from each other, the processing block control section determines the number of parallel processes based on an index for controlling the number of parallel processes other than the upper limit and the lower limit of the number of parallel processes.

9. The distributed processing system according to claim 7, wherein when the upper limit and the lower limit of the number of parallel processes are identical to each other, the processing block control section executes the processing with this identical number of parallel processes.

10. The distributed processing system according to claim 1, wherein the processing blocks include at least one of:
a special-purpose processing block that executes a predetermined function;
a general-purpose processing block that changes its function in accordance with input program information; and
a dynamic reconfigurable processing block that reconfigures hardware based on input reconfigurable information.

11. The distributed processing system according to claim 10, wherein
the processing blocks comprises the special-purpose processing block implemented as software,
the processing element includes the special-purpose processing block prepared in advance, and
the processing element includes a special-purpose processing block holding section that can unload, copy, or delete the special-purpose processing block and hold the unloaded and/or copied special-purpose processing block.

12. The distributed processing system according to claim 11, wherein the special-purpose processing block holding section copies the special-purpose processing block that it holds in accordance with the number of parallel processes.

13. The distributed processing system according to claim 11, wherein the special-purpose processing block holding section loads the special-purpose processing block that it holds to make the special-purpose processing unit capable of processing.

14. The distributed processing system according to claim 10, wherein the processing blocks comprises the special-purpose processing block implemented as hardware, and
execution of a predetermined function and control of the number of parallel processes are performed by connecting/disconnecting a path that interconnects an input of the special-purpose processing block to the division section and a path that interconnects an output of the special-purpose processing block to the integration section.

15. The distributed processing system according to claim 10, wherein
the processing blocks comprises the general-purpose processing block implemented as software,
the processing element includes the general-purpose processing block implemented as software prepared in advance, and
the processing element includes a general-purpose processing block holding section that can unload, copy, or delete the general-purpose processing block implemented as software and hold the unloaded and/or copied general-purpose processing block.

16. The distributed processing system according to claim 15, wherein the general-purpose processing block holding section copies the general-purpose processing block that it holds in accordance with the number of parallel processes.

17. The distributed processing system according to claim 15, wherein the general-purpose processing block holding section loads the general-processing block that it holds to make the general-purpose processing block capable of being loaded with the program information.

18. The distributed processing system according to claim 15, wherein the processing element has a load section that loads program information contained in a library, which is connected to the distributed processing system from outside, in accordance with the task to be executed directly to the general-purpose processing block.

19. The distributed processing system according to claim 18, wherein the processing element includes a library holding section that can unload, copy, or delete the program information contained in the library loaded to the general-purpose processing block and hold the unloaded and/or copied program information.

20. The distributed processing system according to claim 19, wherein
the load section loads the program information to the library holding section, and
the library holding section holds the program information received from outside through the load section.

21. The distributed processing system according to claim 19, wherein the library holding section copies the program information that it holds in accordance with the number of parallel processes.

22. The distributed processing system according to claim 19, wherein the library holding section loads the program information that it holds to the general-purpose processing block.

23. The distributed processing system according to claim 10, wherein
the processing blocks comprises the dynamic reconfigurable processing block, and
the processing element includes a load section that loads reconfiguration information contained in a library, which is connected to the distributed processing system from outside, in accordance with the task to be executed to the dynamic reconfigurable processing block directly from outside.

24. The distributed processing system according to claim 23, wherein the processing element includes a library holding section that can unload, copy, or delete the reconfiguration information contained in the library loaded to the dynamic reconfigurable processing block and hold the unloaded and/or copied reconfiguration information.

25. The distributed processing system according to claim 24, wherein
the load section loads the reconfiguration information to the library holding section, and
the library holding section holds the reconfiguration information received from outside through the load section.

26. The distributed processing system according to claim 24, wherein the library holding section copies the reconfiguration information that it holds in accordance with the number of parallel processes.

27. The distributed processing system according to claim 24, wherein the library holding section loads the reconfiguration information it holds to the dynamic reconfigurable processing block.

28. The distributed processing system according to claim 23, wherein execution of a function implemented by the reconfiguration information and control of the number of parallel processes are performed by connecting/disconnecting a path that interconnects an input of the dynamic reconfigurable processing block to the division section and a path that interconnects an output of the dynamic reconfigurable processing block to the integration section.

29. The distributed processing system according to claim 1, wherein the index for controlling the number of parallel processes includes one or more of the number of parallel processes, priority level, type of quality assurance, electrical energy consumption, processing time, and output throughput.

30. The distributed processing system according to claim 1, wherein
the client specifies a priority level for each of the one or more tasks as the index for controlling the number of parallel processes, and
the processing block dynamically determines the number of parallel processes concerning the execution of the task based on the specified priority level.

31. The distributed processing system according to claim 4, wherein when candidates of the index for controlling the number of parallel processes cannot be determined according to the criteria concerning the execution of the application designated by the client, the control unit presents an alternative index deviating from the criteria.

32. The distributed processing system according to claim 1, wherein
the control unit determines combinations of candidates of the indexes for controlling the number of parallel processes, and
the client presents the candidates of the indexes to a user by a user interface and limits a combination of indexes entered on the user interface to the combinations of the candidates of the indexes for controlling the number of parallel processes determined by the control unit.

33. The distributed processing system according to claim 11, wherein the processing element can unload all of the special-purpose processing block, general-purpose processing block, program information, and reconfiguration information that have already been loaded.

34. The distributed processing system according to claim 4, wherein the criteria concerning the execution of the application includes one or more of the type of quality assurance, electrical energy consumption, processing time, and output throughput.
